(19) United States
(12) Patent Application Publication
(10) Pub. No.: US 2010/0274859 A1
(43) Pub. Date: Oct. 28, 2010

(54) Method And System For The Creation, Management And Authentication Of Links Between Entities

(76) Inventor: Asim Bucuk, London (GB)

Correspondence Address: Asim Bucuk;Gordan Milinkovic, 28 St James Mansions, London, NW6 2AA, omitted

(21) Appl. No.: 12/601,008

(22) PCT Filed: May 23, 2008
(86) PCT No.: PCT/GB2008/050377

§ 371 Date: Jul. 14, 2010

(30) Foreign Application Priority Data
May 24, 2007 (GB) 0710012.6
Jun. 1, 2007 (GB) 0710530.7
Sep. 27, 2007 (GB) 0718855.0

(51) Int. Cl. G06F 15/16

(52) U.S. Cl. 709/206; 709/248

(57) ABSTRACT

Methods and systems for establishing relationships and creating links between entities (such as users, devices, organisations etc) are described. The method comprises receiving at a device over a short range communication means, an identifier which relates to a nearby device. This identifier is sent to a server associated with the device and at least an identifier for a data object is also sent to the server. The server makes the data object available to an entity associated with the nearby device by associating the identifier for that entity and the identifier for the data object. The data object may comprise a packet of data (e.g. a file or document), a link to data stored elsewhere or a collection of data (e.g. a collection of contact details). The nature of the relationship established is determined by the data packet.

### TECHNICAL FIELD

The present invention relates to a communication system which simplifies the development, management and authentication of relationships between people, organisations, objects and machines.

### BACKGROUND

Currently, mobile phone users have the option of sending a business card using short range communication including but not limited to Bluetooth®, infrared, or long range communication including but not limited to GPRS or UMTS. However because the information is sent as a business card to a recipient he or she is not able to confirm authenticity of the data received nor manage relationships and ownership of the contact data or bonding between people, organisations, objects and machines in order to get access to information or services or physical devices in real time.

Additionally there are NFC systems used for payments or public access transport access but using a centralised system typically embedded in a plastic card or SIM card on mobile phones which works only up to 5 centimetres. However, no existing system offers the user multiple services (e.g. credit card services and/or banking services from different providers) running together on the same device, and the possibility to add new services very simply and cheaply. Therefore implementations of such systems are expensive and often need a centralised governing body (Trusted Service Provider) on national level.

Additionally there are problems such as that users have to remember a multitude of passwords to access for example websites, the impossibility of verifying the true identity of a user for authorising access to public transport, or an international border, or for exchanging currency.

Systems exist in which static contact information from mobile phones can be wirelessly synchronised to a single remote server, which requires people or businesses to put their employee's personal data, and their business relationships and access to any information or physical places into the hands of the service provider controlling the data on the world wide centralised system.

In another existing system mobile phone contact information is uploaded to a remote server and then synchronised between remote servers. This has serious practical limitations as the data must initially be manually entered by, and exchanged between different users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In order to provide authenticated access for a person, to access the personal data of his contacts, to control a device, or to access an electronic service, the user is provided with a server. After they register their mobile device to the server and its data, the server then authenticates the mobile device as representing them or being controlled by them. This server may be referred to as an authentication server.

When the user attempts to use their mobile device to access such data, device or service, provided by a remote system, that remote system will record a unique identifier of their mobile device. Means are provided for permitting the remote system to determine the user's authentication server (e.g. the server's IP address). These means are either by making a request to a pointer server, or by encoding this information in data sent from the user's mobile device to the remote system (e.g. the authentication server IP address may be encoded within the unique identifier), where a short range communication (e.g. Bluetooth, WiFi, RFID, NFC, Ultra-wideband or Infrared or NTT's RedTacton) or GPS or LBS may be used at least in one step of the process.

The remote system requests confirmation from the user's authentication server that the user is indeed using the uniquely identified mobile device, and further that the mobile device is being used to access the remote system. On confirmation by return, the user via his mobile device is authenticated, and is authorised to access the desired resource.

After registering the necessary information for their identity and logging onto the system using a mobile device, a user may search for nearby enabled devices, determine at least the names of the users or other information related to those devices, and select a set of information, or a pointer to a set of information, to which other users may be granted access, effectively creating a bond. Once given access, those other users may continue to have access in the future or access may be time limited. Additionally, when the devices are then separated by physical distance, the internet may be used to access this information. Further, those other users may access authorised resources using alternate devices, for example if they lose their mobile phone. In such case, a replacement device may be used by simply logging to the software installed on the replacement device (or, more precisely, logging to the authentication server via the replacement device) using a password or biometrics. After the creation of such a bond between a user and another entity, the user might be provided with access to additional resources or objects related to that entity. These resources may be accessed for example using short range communication (for example the resources may be part of a business computer, public transport, a cash point, a car or house) and/or using connections to the internet to the user's system (or their service provider system which ultimately connects to the user's system). Additionally they can access particular information via an internet connection even where short range communication is not available. The process involves particular data including but not limited to a Unique ID exchanged between devices, to form, capture or authenticate links between the users of the system (more specifically between any of users/entities/devices and other users/entities/devices).

The separation of server functionality into pointer servers and authentication servers may be used to bypass the need to exchange an IP address of an authentication server and/or to avoid the need for users to store personal data on a server that they do not have control over (i.e. the data can be on a company's server, and pointer servers indicate that the data for certain devices and users is on that company server—but a pointer server provider company need not have access to the data).

The provision of two-way authentication for access is made possible by providing each device owner with an associated server (whether an individual or a company), and avoiding the need to place (personal or company) data into a third party centralised server.

Different methods are possible for one device to determine the location of the authentication server of the other device and multiple services being used on the same system as will be detailed.

Generally the system uses unique identifiers, including but not limited to the serial numbers of the communications modules of the devices. Additionally there is the feature of verification of identity, to prevent such identifiers being spoofed. Verification is generally performed between two authentication servers.

The system also addresses problems of users having to remember many passwords and also the difficulty of verifying the true identity of a user.

The system described herein may be distributed and thus every data owner can hold on to their data and allow access only on a need to know basis. Additionally, in some embodiments, the system allows for one of the devices not to have a dedicated internet connection and yet enables secure authentication by tunneling identity management through another device/s participating in network.

There are many uses of the methods and systems described. Some example applications are described below.

Methods and systems for establishing relationships and creating and capturing links between entities (such as users, devices, organisations etc) are described. The method comprises receiving at a device over a short range communication means, an identifier which relates to a nearby device. This identifier is sent to a server associated with the device and at least an identifier for a data object (or link object) is also sent to the server. The server makes the data object available to an entity associated with the nearby device by associating the identifier for that entity and the identifier for the data object. The data object may comprise a packet of data (e.g. a file or document), a pointer to data stored elsewhere or a collection of data (e.g. a collection of contact details). The nature of the relationship established is determined by the data object.

A first aspect provides a method for creating a link between entities comprising: receiving from a first device at a server associated with the first device, an identifier relating to a second device, the identifier having been received by the first device from the second device using a short range communication means; receiving from the first device at the server associated with the first device, an identifier for a data object; and making the data object available to an entity associated with the second device by associating the identifier relating to the second device and the identifier for the data object.

The method may further comprise: in response to receiving the identifier relating to the second device, identifying a server associated with the second device; sending a message to the server associated with the second device, the message including the identifier relating to the second device and an identifier relating to the first device; and receiving an identifier for an entity associated with the second device from the server associated with the second device.

The identifier for an entity associated with the second device and the identifier relating to the second device may be the same and might include an identifier for specific service (i.e. contacts, banking, passport) or different providers inside of same service (e.g. different bank accounts inside of banking service).

The method may further comprise: on receipt of an identifier for the entity associated with the second device from the server associated with the second device, sending the identifier for the entity associated with the second device to the first device.

The identifier for a data object may be received from the first device after sending the identifier for the entity associated with the second device to the first device.

The server associated with the first device may be located within the first device. The server associated with the second device is located within the second device. The two servers may be the same server.

The method may further comprise receiving a new data object from the server associated with the second device.

The method may further comprise receiving from a first device at a server associated with the first device, an identifier relating to a third device, the identifier having been received by the first device from the third device using a short range communication means; receiving from the first device at the server associated with the first device, an identifier for the new data object; and making the new data object available to an entity associated with the third device by associating the identifier relating to the third device and the identifier for the data object.

The new data object may comprise a new identifier relating to the first device.

The identifier for an entity associated with the second device may comprise at least one of a name and a picture of the entity.

The method may further comprise: sending a confirmation message to the server associated with the second device. The confirmation message may comprise an identifier relating to the first device and an identifier for an entity associated with the first device.

The method may further comprise: at the server associated with the second device: sending the identifier for the entity associated with the first device to the second device; receiving from the second device, an identifier for a second data object; and making the second data object available to an entity associated with the first device by associating the identifier relating to the first device and the identifier for the second data object.

Identifying a server associated with the second device may comprise: identifying an IP address of the server associated with the second device. The identifier relating to the second device may include the IP address of the server associated with the second device. In another example, identifying a server associated with the second device may comprise: sending a request to a pointer server asking for at least an IP address of the server associated with the second device, the request including the identifier relating to the second device.

The method may further comprise: at the first device, in response to a trigger, requesting identifiers relating to any devices in close proximity using the short range communication means.

Making the data object available to an entity associated with a device may further comprise: sending the data object to the server associated with the device.

The method may further comprise: periodically synchronising the data object with the server associated with the device.

The method may further comprise: periodically synchronising the data object with the device.

A second aspect provides a method for creating a link between entities comprising: receiving, at a first device over a short range communication means, an identifier relating to a nearby device; sending the identifier relating to the nearby device to a server associated with the first device; selecting a data object to share with an entity associated with the nearby device; and sending an identifier for the data object to the server associated with the first device.

The method may further comprise: at the first device prior to receiving an identifier for a nearby device: in response to a trigger, requesting an identifier of a nearby device in close proximity.

The method may further comprise: after sending the identifier relating to the nearby device to the server: receiving an identifier for the entity associated with the nearby device; and displaying the identifier for the entity associated with the nearby device.

The identifier for the entity associated with the nearby device may comprise at least one of a name and a picture of the entity.

The method may further comprise: amending an identifier relating to the first device to include an IP address of the server associated with the first device.

The method may further comprise: sending the data object from the first device to the nearby device over the short range communication means.

Sending the data object from the first device to the nearby device may comprise: receiving an encryption key from the server associated with the first device; encrypting the data object using the encryption key; and sending the encrypted data object from the first device to the nearby device.

If the first device has no long range communication means, sending the identifier relating to the nearby device to a server associated with the first device may comprise: sending the identifier relating to the nearby device over the short range communication means to the nearby device for forwarding to the server associated with the first device over a long range communication means associated with the nearby device.

If the nearby device has no long range communication means, the method may further comprise: receiving a message for forwarding from the nearby device; and forwarding the message to a server associated with the nearby device over a long range communication means associated with the first device.

The method may further comprise: receiving a key from the server associated with the first device at one of the first device and the nearby device; and using the key to access the other of the first device and the nearby device. The key may be used to access a third device.

A third aspect provides a system for creating a link between entities, the system comprising: two wireless devices, each comprising a short range communication means and at least one comprising a long range communication means; a first server associated with a first of the wireless devices and comprising authentication data relating to the first of the wireless devices; and wherein the first of the wireless devices is arranged to: receive an identifier relating to the second of the wireless devices via the short range communication means; send the identifier relating to the second of the wireless devices to the first server; select a data object to share with an entity associated with the second of the wireless devices; and send an identifier for the data object to the first server.

The first of the wireless devices may include the server associated with the first of the wireless devices.

The data object selected for sharing may be a predefined object, and each user may have a default option among such predefined objects, e.g. a private contact link. In this case, when two mobile phone devices come in close proximity and no other option is selected, they go to private contact bonding.

The first server may be arranged to: receive the identifier relating to the second of the wireless devices from the first of the wireless devices; receive the identifier for the data object from the first of the wireless devices; and make the data object available to an entity associated with the second of the wireless devices by associating the identifier relating to the second of the wireless devices and the identifier for the data object.

The system may further comprise a second server associated with a second of the wireless devices and comprising authentication data relating to the second of the wireless devices.

A fourth aspect provides a server comprising: a data store comprising authentication data associated with a first device; means for receiving, from the first device, an identifier relating to a second device, the identifier having been received by the first device from the second device using a short range communication means; means for identifying a data object associated with the first device; and a data store for storing and associating the identifier relating to the second device and the data object.

The means for identifying a data object associated with the first device may comprise: means for receiving, from the first device, an identifier for a data object. The data store may be arranged to store and associate the identifier relating to the second device, the identifier for the data object and the data object.

The server may further comprise: means for identifying a server associated with the second device; means for sending a message to the server associated with the second device, the message including the identifier relating to the second device and an identifier relating to the first device; and means for receiving an identifier for an entity associated with the second device from the server associated with the second device.

The server may further comprise: means for sending the identifier for the entity associated with the second device to the first device.

A fifth aspect provides a method for creating a link between entities comprising, at a server: receiving from a first device an identifier relating to a second device, the identifier having been received by the first device from the second device using a short range communication means and the identifier being received at the server using a long range communication means; and creating a link between an entity associated with the first device and an entity associated with the second device by associating the identifier relating to the first device and the identifier associated with the second device.

The method may further comprise: receiving from a second device an identifier relating to the first device, the identifier having been received by the second device from the first device using a short range communication means and the identifier being received at the server using a long range communication means;

The method may further comprise: making a data object associated with the entity associated with the first device available to the entity associated with the second device.

The method may further comprise: making a data object associated with the entity associated with the second device available to the entity associated with the first device.

The step of creating a link between an entity associated with the first device and an entity associated with the second device by associating the identifier relating to the first device and the identifier associated with the second device may comprise: sending a confirmation request message to at least one of the first device and the second device; and on receipt of a confirmation message from at least one of the first and the second device, or on receipt of a confirmation message from both of the devices, creating a link between an entity associated with the first device and an entity associated with the second device by associating the identifier relating to the first device and the identifier associated with the second device.

A further aspect provides a method for modifying an IP address of a client device so it contains a unique identification code of an entity, the method comprising: Setting of an network 64-bit (sub-) network prefix of an IP address to network part of an IP address locating the client device on the internet by using an IP address, Setting of a network 64-bit host part of an IP address to network part of an IP address so it contains a unique identification code of an entity.

Another aspect provides a method for modifying an IP address of a client device so it contains an IP address of a client's authentication server, the method comprising: Setting of an network 64-bit (sub-) network prefix of an IP address to network part of an IP address locating the client device on the internet by using an IP address, Setting of a network 64-bit host part of an IP address to network part of an IP address locating the authentication server on the internet by using an IP address.

Further aspects of the invention include:
A server arranged to pull data from an authentication server
A method providing contact data
A method of transferring currency. In such a method, the nearby device may be a currency dispensing machine.
A method of identification
A method of providing access to services, media, storage devices etc
A method of advertising.

A further aspect provides a computer program comprising computer program code means adapted to perform some or all of the steps of any of the methods described herein when said program is run on a computer. The computer program may be embodied on a computer readable medium.

The methods described herein may be performed by firmware or software in machine readable form on a storage medium. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

For a better understanding of the invention and to show how the same may be carried into effect, reference will now be made, by way of example, to the accompanying drawings, in which:

FIG. 1a shows a schematic of a system according to an embodiment of the present invention, using external authentication server architecture and a pointer server,

FIG. 1b shows a schematic of the system according to another embodiment, without external authentication server and/or a pointer server,

FIG. 1c shows a schematic of the system according to another embodiment, where only one device has access to the internet,

FIG. 1d shows a schematic of the system according to another embodiment, where centralized server is used to login mobile devices,

FIG. 2 shows a schematic of how a system from FIG. 1 can be expanded vertically i.e. how more pointer servers could be added for faster and simpler communication,

FIG. 3 shows a schematic applicable to many different embodiments of the system,

FIG. 4 is a graphical representation of devices and authentication servers related to a single user or entity,

FIG. 5 is a simple representation of a database structure and underlying data used by first user,

FIG. 6 is a simple representation of database structure and underlying data used by second user,

FIG. 7 is a simple representation of database structure and underlying data used by first user employer, and

FIGS. 8-11 show example flow diagrams of methods described herein.

Common reference numerals are used throughout the figures to indicate similar features.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well known features may be omitted or simplified in order not to obscure the present invention.

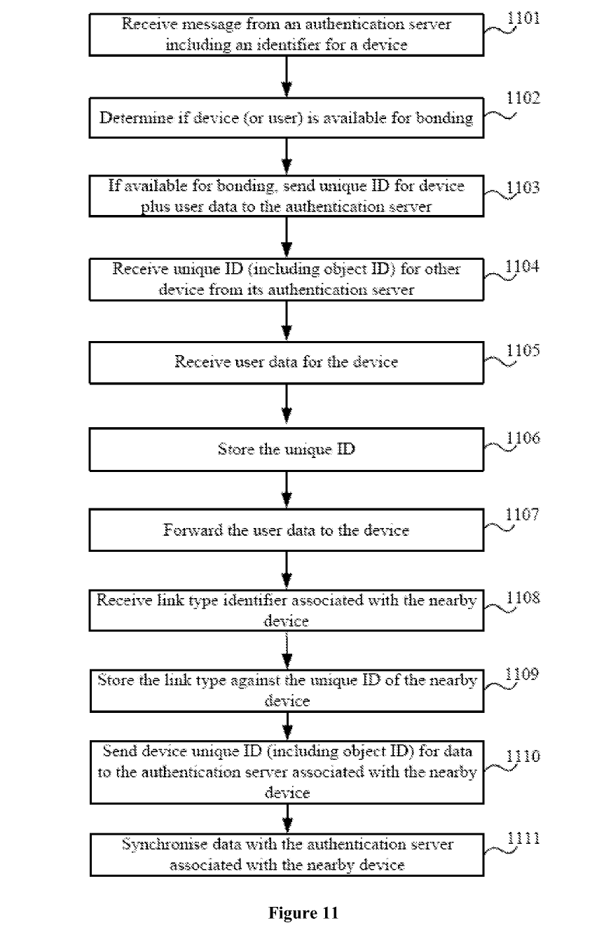

The methods described below can be described with reference to the figures and in particular FIG. 8 which shows the operation of a first device (110), FIGS. 9 and 10 which show the operation of the authentication server (112) associated with that device and FIG. 11 which shows the operation of the authentication server associated with the nearby device. Depending on the method, the operation of the nearby device may be similar to that shown in FIG. 8. Whilst the following description may refer to one or both of the devices as being mobile devices or mobile phone devices, this is by way of example only. Dependent on the particular application, either one or both of the devices may be mobile devices and these mobile devices may be mobile phones or other mobile devices such as devices partially or completely embedded in a user's clothes or body. Whilst the following description may refer to activities of users, this is by way of explanation only and may alternatively be replaced by any type of entity.

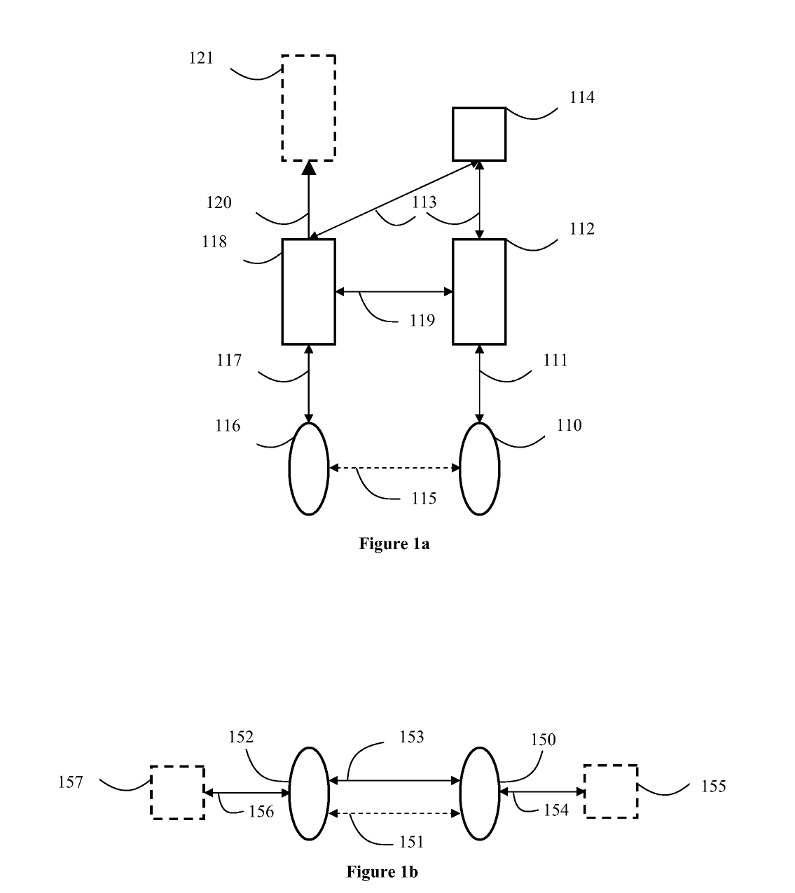

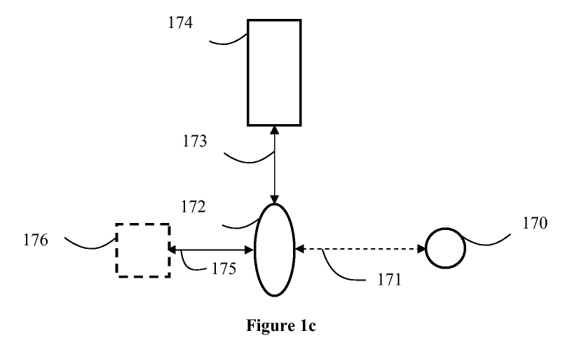

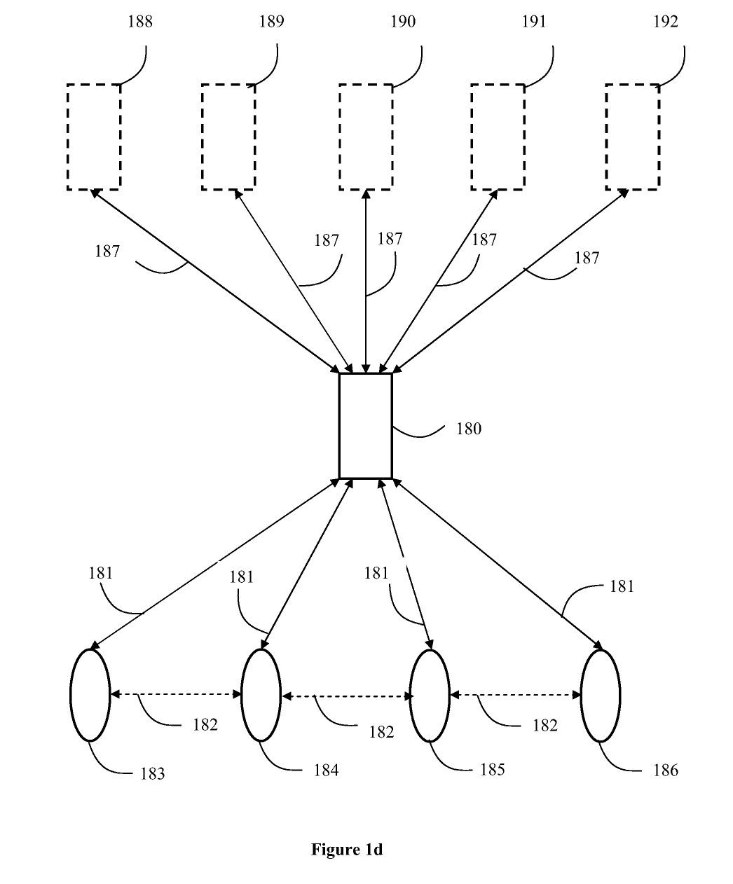

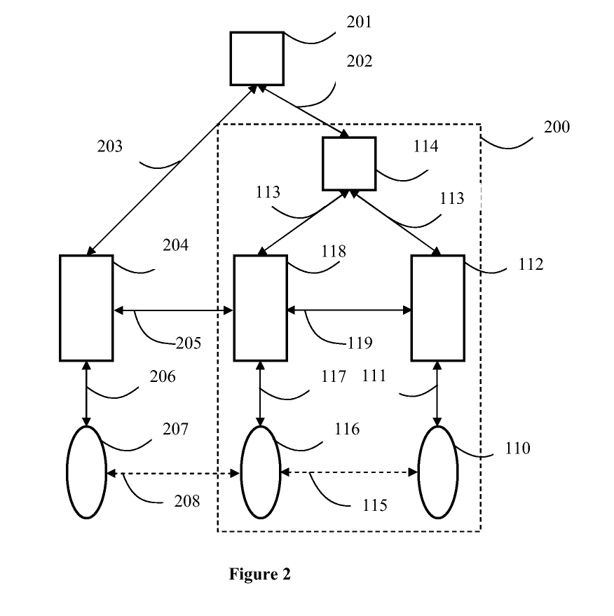

Once software (which may be downloaded after purchase of a mobile phone device or loaded during the mobile phone device's manufacturing process), is installed and run for the first time on the mobile phone device (110) as in FIG. 1a, it will register with an authentication server (112) using an internet connection (111). This is also shown in block 801 of FIG. 8. Typically the Internet connection would be via GPRS or UMTS but it could be any other type of data transfer between a mobile phone device and the authentication server. The mobile device may comprise a short range radio connection (115) including but not limited to Bluetooth®, WiFi, Ultra-wideband, RFID, NFC, RedTacton or Infrared.

If this is the first time that the user is using the service, the authentication server will register the new user or entity by creating a new account in its database using some unique identification (block 901 of FIG. 9). The mobile phone device unique ID could be randomly generated by the system or predetermined by the hardware or software of the authentication server (112) or the mobile phone device (110). In one preferred embodiment, the mobile phone device will provide an electronically engraved BD_ADDR number, which will be registered in the database of the authentication server (112). BD_ADDR is a 42 bit IEEE Bluetooth device address unique to each Bluetooth® module. Similarly, for example, in embodiments utilizing WiFi, BSSID might be used instead of BD_ADDR.

There are two main methods for the creation of a link (bonding) between device (110) and device (112) as follows. The same methods also apply to the creation of a link between a user or entity in control of device (110), and a user or entity in control of device (112), as will be explained later.

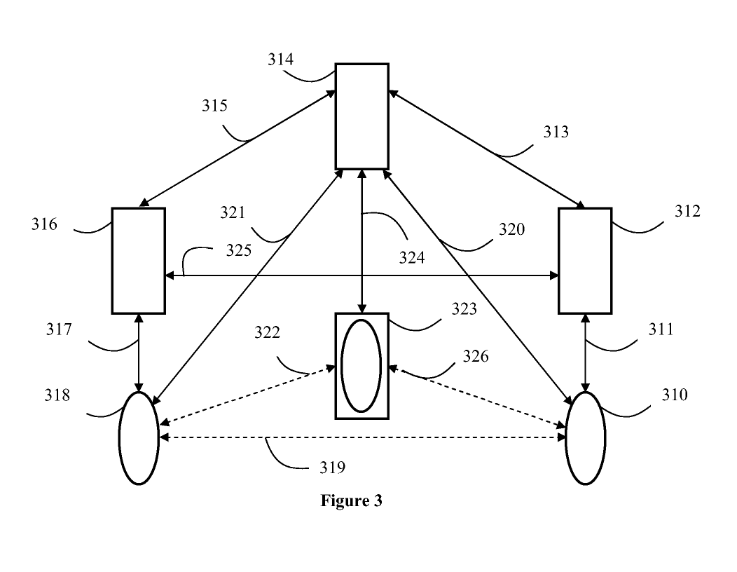

The first method is where an IP address of an authentication server is exchanged and available, possibly using a User ID, in which case there is no need for a Pointer Server (114) in FIG. 1 and (114, 201) in FIG. 2.

The first method could be achieved by changing the Bluetooth® name of a mobile phone device to contain an authentication server IP address and/or a User/Device unique ID and/or an Object ID as necessary. For example if John Smith's authentication server's IP address is 123.123.123.123 and his User ID for this particular authentication server is 55 and Object ID is 01 which could be different for different services then his unique ID would be 1231231231235501, which could be embedded in John's mobile phone device name. His new mobile phone device name might look like “John@1231231231235501”, from which any other device could read the location of John's authentication server as well as the Unique User/Device ID and Object ID, if necessary. Note that the word ‘John’ before the “@” symbol and the Unique ID number are not necessary for the system to function as users are not reading this information only the system.

In another example, the first method could be achieved by inserting an IP address of an authentication server responsible for a device and/or a Unique ID into an RFID or Near Field

Communication (NFC) tag of the device to be transmitted to requesting nearby device. In another example, if the IP address of a responsible authentication server is not included in the tag then a pointer server may be used to resolve the Unique ID to a responsible authentication server IP address.

Yet another way to exchange the Unique ID of an authentication server would be to use the OBEX communication protocol over the short range communication connection, whereby all necessary information could be passed, including but not limited to an IP address of an authentication server and/or a User ID and/or an Object ID. Note that this can be done with or without including an IP address of an authentication server, so applies to both main methods of bonding.

Yet another way to exchange the Unique ID of an authentication server would be to use a single authentication server where both users and/or devices have logged in. In such case it is not necessary to use an IP address of an authentication server as for both users and/or devices it would be the same. In some cases it may not be necessary to use Object ID in addition to Unique ID as Unique ID might be related to Object ID only at authentication server responsible for generation of Unique ID. In some cases of use Object ID could be omitted all together.

For a secure encrypted short range communication, a PIN may be used. The same PIN may be sent to two nearby devices from a pointer server, authentication server or other server so that other nearby device/s cannot intercept short range communication between the two devices although the system is secure even if other nearby device can read short range communication.

A second method is where only the Unique ID is known but not an authentication server's IP address responsible for that particular Unique ID (in this example the BD_ADDR of a Bluetooth® module). This problem is overcome by using a Pointer Server, which relates any Unique ID to the IP address of its authentication server. The authentication server will further resolve data or objects relating to the entity and any links it has towards other entities or devices.

However, in an example that follows, there will be an exchange of a Unique Device ID including but not limited to BD_ADDR without an authentication server IP address being exchanged in a short range communication, but instead using a Pointer Server. Note that other identification could be used instead of BD_ADDR, including but not limited to,:
a WiFi device name
a Service Set Identifier (SSID) identification number (access point number) (BSSID)
the MAC address of a network card or other hardware specific unique numbers
a user's phone number
other short range wireless radio identification exchanged between RFID or NFC devices, or
a number, a string or a code, or
a changing number, a string or a code, periodically generated according to an algorithm.

Alternatively the unique number could be a static or dynamic number generated by the system on the server or client side. The following description uses the BD_ADDR by way of example only.

The system will generate a unique entity ID and related data sets for the user on the authentication server. So even if a user changes his mobile phone device or if he changes his data connection, the user's unique identification and links to other users and entities can be maintained. During the registration process a user can supply any other information (for example their name, telephone number, email, address, picture, video, etc) which is then directly related to them in the database, and different sets and combinations of this information allow a multitude of different link types (for example Private, Business, Hobby or Charity contact links). This information could be added not just by a user but by other machines or users or entities or services as will be discussed later in the description.

Additionally a user may supply a first private password, for him to log onto the system so he can later add devices, change his data or manage links. Additionally the user may supply a second public password, which may be used as verification of his identity, for example to access a third party website which would be then automatically populated with his contact information (for example if it was an email provider) or other data (for example for a social networking website). Note that there is no need for the second password to be used when accessing a website automatically using short range communication as will be explained below.

Additionally, once users have added one or more social networks to the information related to their account on the authentication server, they could have their profiles compared for a multitude of social networks and see if they have any mutual friends by exchanging at least their Unique ID over a short range communication connection between devices, where at least one device also has a long range communication connection. As well, friends not participating in a particular service could be invited through and/or by the system, with or without the user's interaction.

According to one embodiment, if this is the first time the authentication server (112) is run and attempts to connect to the pointer server (114), the pointer server might request the authentication server to identify itself and create an account. In other embodiments this is not required. The authentication server (112) will be supplied with the IP address of the nearest pointer server in advance.

According to one embodiment, at this stage the authentication server (112) requests the pointer server to register the mobile phone device's (110) 42 bit unique BD_ADDR number against the IP address of that authentication server (112). This request uses the low-level data protocol TCP/IP (or optionally HTTP/XML or a substitute protocol). The IP address of the authentication server could be found from the TCP/IP request header.

The process will be successful only if no one else has already registered this BD_ADDR number. If there are any pointer servers nested above, then the uniqueness of the number needs to be checked all the way to the top (world-wide) pointer server. This step enables system integrity and stability as will be explained in more detail below.

Another option would be not to have a pointer server, but instead to transfer the Unique ID and/or authentication server IP address using an alternate method (E.g. SMS, MMS, email, WAP push, voice, manual input etc) for future short range communication use. One example would be cash point terminal for particular bank where once activation SMS containing Unique ID will be sent to mobile phone device, software will always know, when in short range communication with bank's cash point, which bank's IP address to contact (if needed) and which Unique ID to use for particular bank's (cash point's) BD_ADDR or BSSID. It could change own SSID (name) according to pre arranged software design including information supplied in an alternate method mention above.

Once a mobile phone device has been registered with pointer server, the authentication server must release the BD_ADDR number from it before any other authentication server or user or entity could use that number on this particular system with pointer server. Once pointer server (114) successfully registers the device, the pointer server (114) will confirm to the authentication server (112) using a data connection (113).

After each participating device, such as (110) and (116), has completed registration and logged onto the authentication server, (112) and (118) respectively (blocks 802 and 902), they are ready to participate in the system.

There are a number of different ways in which the process may be initiated following registration and the process may be initiated based on any trigger, including but not limited to a user input, an external trigger (e.g. from over the internet or by coming into a close proximity with an NFC device), an internal trigger (e.g. as a result of an event within software on the device). In one preferred embodiment, the user of a mobile phone device (110), as shown in FIG. 1a, may press one button (or make a menu selection) which will launch the software installed on the mobile phone device and request the Bluetooth® built in radio module to use a radio connection (115) to request the BD_ADDR numbers of all devices in close proximity (E.g. up to 100 meters), as shown in block 803 of FIG. 8. In another example, the process may be started automatically when a device senses another in close proximity. The proximity sensing may use NFC, RFID or any other suitable technology. The devices may use active technology (i.e. where they include a powered tag) or passive technology (i.e. where they include a tag without battery which can be read by a reader in another device). In a further example, the process may be triggered by an event, which may be initiated by the device's operating system, an application run by the device or by an external entity. Further examples may use a combination of the above initiation techniques.

For the purposes of the following description only, mobile phone device (110) is considered to be initiating the process and mobile phone device (116) is close to mobile phone device (110). For purposes of clarity, mobile phone device (116) will be referred to as the ‘nearby device’.

At this time or soon after it has collected all available BD_ADDR numbers (block 804), the mobile phone device (110) will register with an authentication server (112) that it is available to be bonded with another device or entity (blocks 805 and 903). Whilst the description above and below refers to devices being able to be bonded, in other embodiments it may be the user/entity that is available for bonding. Where the bonding flag relates to the user/entity, when the user/entity is available for bonding, there may be more than one device which may be used.

Additionally more complex structures for entity/user/device relationships (and also bonds) may be used, such as for example every entity might include or be related to many users and a user may be related to many devices, and several levels of flags for bonding availability may be used and set at different times dependant on task being achieved at that point of time.

According to one embodiment, once one or many BD_ADDR addresses have been collected from nearby mobile phone devices (116) they will be sent (blocks 806 and 904) using a GPRS/UMTS connection (111) (or substitute service) to the authentication server (112) which will send a request to the pointer server (block 905a of FIG. 10) (114) asking for at least the IP address of the authentication server responsible for the BD_ADDR numbers of those nearby mobile phone devices (116). In this embodiment the pointer server (114) will return (block 905b) to the authentication server (112) the IP address of the authentication server(s) (118) responsible for the nearby device(s) (116). At this stage the relationship between the BD_ADDR number and its responsible authentication server IP address could be stored locally for future use, and only after it ceases to be valid would the authentication server seek clarification of the current relationship between the BD_ADDR number and its authentication server IP address, from the pointer server.

The process described above may be repeated for any devices, such as (110) and (116), participating in a short range communication network and available to be bonded with at a particular time, even if not mentioned in the examples below (as indicated by dotted arrows in FIG. 9).

Upon receiving information (in block 905b) from the pointer server (114) indicating the IP address of the authentication server (118) associated with the BD_ADDR number of the nearby device (116), the authentication server (112) associated with the first device will contact the authentication server (118) associated with the nearby device at the provided IP address (block 906), with data which includes the relevant BD_ADDR number of the relevant nearby device (116), using in this example, an XML connection (119). This contact constitutes a request from the authentication server (112) to the authentication server (118) that a user of the nearby device (116) associated with the authentication server (118), identified by a BD_ADDR number, should link with a user of the first mobile phone device (110). Once this request is received (block 1101 of FIG. 11) by the authentication server (118) associated with the nearby device, it will search its database for a data entry indicating registration of such a mobile phone device and for data indicating whether the device (116) or its user is available for bonding (block 1102).

It is possible to register the bonding availability of a device (110) with a pointer server (114), rather than an authentication server (112) but in this instance the user data would be stored on the same centralised server and/or database used for managing the BD_ADDR number registration. This would not be the best solution for many entities, as they would not be willing to store their most sensitive data remotely using someone else's hardware and/or software solution.

Also in, for example, a small company, the same physical server machine could be used as a pointer server and an authentication server. Note therefore that here, the term server means software operating on hardware. The two servers may be separate, but may in some cases operate on shared hardware.

If the nearby device (116) is registered with the authentication server (118) and available to be bonded with, then the authentication server (118) in this example will reply to the authentication server (112) with the Unique entity ID for this user, user's name and, optionally the user's picture, depending on which user is registered with the nearby device (116) at the current time (block 1103). The authentication server (118) associated with the nearby device may also provide additional information (in block 1103), for example, a service ID or PIN may be provided (as described below).

The Authentication server (112) will store (block 908) the Unique Entity ID in its database and forward (block 909) the name (and optionally the picture) of the user currently using the nearby mobile phone device (116), to the first mobile phone device (110) where it will be displayed (blocks 807 and 808) on the screen of the first mobile phone device (110), and be available for selection by the user of the first mobile phone device (110). It would be possible to have many users displayed on the screen with or without pictures, if many BD_ADDR numbers had been collected during the search phase (e.g. for each of the nearby devices). This could happen for example during a busy business exhibition where there are many devices in bonding mode. Any additional information provided by the authentication server (118) associated with the nearby device may be forwarded to the mobile device (116) and/or retained at its associated authentication server (112).

The process above could be repeated automatically for several minutes until a user becomes available for bonding. Upon seeing a picture and user's name displayed on the screen of the first mobile phone device (110), the user may select it and could be offered a selection of his own link types (in a personal bonding scenario these might include private, business, and hobby options, in another scenario, based on service ID, the options might represent bank accounts available to transfer money to another service user). This action defines the type of link with the user of the nearby device (or more precisely defines the Link Object available to the other user after the linking process has finished). The link object could be contact data, pictures, video etc, but also other data sets or rights, for example access permissions, as will be explained below. After the selection is made (block 809) on the first mobile phone device (110), details of the selection will be sent (blocks 810 and 910) to the authentication server (112) which will store this information (block 911) against another user/entity ID in its database which makes particular data set(s) of user of mobile phone device (110) always or temporarily available to the user of the nearby mobile phone device (116) and the authentication server (118) associated with that nearby device.

After this step it will send confirmation of the link together with a Unique Entity ID for the user of the first mobile phone device (110), containing Object ID or Object IDs pointing to all necessary information on authentication server's (112) database (additionally all attached data sets could be added) and send them to the authentication server (118) associated with the nearby device (blocks 912 and 1104). The data sent to the authentication server (118) associated with the nearby device may also include user data for the user of the first mobile phone device (110, as received in block 1105). At this point, the server (118) could send a request to the nearby mobile phone device (116) and await authorisation to accept the type of link from the user of the first device (110), or it could simply accept it automatically from the authentication server (112) and optionally send confirmation to the nearby mobile phone device (116). At this step, the authentication server (118) will write in the database (create a Link including a Unique Entity ID (block 1106)).

At the same time the authentication server (118) may forward the User's name and optionally picture to the nearby mobile phone device (116 block 1107) and await selection of a user and a type of linking (in a corresponding manner to that described above in relation to the user of the first mobile device (110)). Once this information is returned to the authentication server (116 block 1108) it will be saved in the database (block 1109) and sent to the authentication server (112) associated with the first device. The information sent may include a Unique Entity ID for the user of the nearby mobile phone device (116 block 1110) containing object ID pointing to all necessary information, which will be stored in the database of the authentication server (112) and optionally await authorisation from the user of the mobile phone device (110). After authorisation is received (if required) both authentication servers may synchronise data attached to the created links (exchange link objects, not only their identifiers), and make this information available to the respective mobile phone devices (blocks 913 and 1111).

Whilst in the above description the Unique ID is described as including the Object ID, in other embodiments, the Unique ID may be provided along with a separate Object ID, for example sent one after the other (e.g. sent in blocks 912 and 1110 and received in blocks 907 and 1104).

After this step, bonding is completed and both mobile phone devices (110), (116) are removed from the list of available bonding devices on their authentication servers (112) and (118) respectively.

The bonding established between the two devices may be long term or may be for a limited period of time or for a particular action. Furthermore, the bonding may be conditional on the two devices remaining in close proximity to each other. Where the bonding is only short term, the unique IDs and/or the link objects and/or link object identifiers may be deleted from the authentication servers after a predefined period or after a particular action (or transaction) is completed. In another example, the devices may continue to ‘ping’ each other to confirm that they are still in proximity and once they are no longer in proximity, this may trigger the deletion of entries from the appropriate authentication servers.

In a further variation on the methods described herein, the short range communication between the first device and the nearby device may be used for an initial exchange of data which may subsequently be synchronised (as in blocks 913 and 1111). This may be beneficial where the cost of sending data over long range communication methods (such as the internet, cellular network etc) may be high whilst there may be no monetary cost for sending data over the short range communication connection established between the two devices in order to bond. In such an example, the data may be sent along with the unique ID (as received by a device in block 804) or at a later stage in the process, e.g. once authentication is completed or the link type confirmed (e.g. after block 810). This communication between the two devices over the short range communication connection may be unencrypted or alternatively, where a PIN or other encryption details are provided using NFC technology and/or by their authentication server/s (e.g. over mobile phones internet connection), this may be used in encrypting and decrypting the data for communication between the two devices. The same encryption key/PIN may be used for the bidirectional data transfer or different encryption keys/PINs may be used for each direction of data flow (e.g. first device to nearby device and nearby device to first device) In a further example, this initial data may be exchanged within the RFID or NFC for a device.

If a user is removed from the list of devices which are available for bonding, no other arbitrary entity can request access, even of the user's basic identification including but not limited to the user's name or picture, which is typically available during the bonding phase.

If for example a user of a mobile phone device (116) wants his data to be discoverable by others he could select the required data to be published by the authentication server (118) to an Entity Name Server (121) using, for example an XML connection (120). The Entity Name Server (121) might need the authentication server (118) to register with it before authorising such publication. Typically during registration the authentication server (118) will be provided with its own unique ID, authentication details and/or own IP address, which could be taken from a header of a TCP/IP request to a centralised Entity Name Server system.

The published data could have visible and/or hidden data sets for those searching. Every registered entity should provide a Unique Entity ID, which includes the IP address of their authentication server. The “push” model where contact data is published to an entity name server is preferred to the “pull” model where the entity name server must periodically search for such data on all available authentication servers. Data will be published to an entity name server by a ‘push’ mechanism rather than a ‘pull’ mechanism only if there is a change in the particular data set so the entity name server is updated by authentication server practically instantly. A push mechanism is also preferred for synchronising changed data between authentication servers.

In one embodiment, users of the system would not need usernames, but instead could use visible and hidden data sets on the Name Server for a users' logon and authorisation to any connected system. For example any website server, mobile phone device or other device could connect to an entity name server (121) offering only two fields. Firstly a “user name” field which could be dynamic and secondly a “public password” field for logging on. The first time a user registers for a service with a website he would be required to provide his user name, which could be dynamically resolved to a Unique ID consisting of an authentication server IP and an Unique Entity ID from data published to the entity name server (121) using, for example Asynchronous JavaScript and XML (AJAX), effectively enabling a user to type in any string of the words, and in real time reduce the number of users associated with that collection of words to only one. The collection of words could be made of visible and/or hidden published words for a particular user. Purpose of hidden words is so no other system participant can see confidential information including but not limited to another user's postcode or try to mimic dynamic resolution of another user's data to own Unique Entity ID.

Once the collection of words has resolved to only one user (referenced by a Unique ID) of the system, for example using “Dave” as the visible word and “SW191AA” (the postcode) as hidden, the user would be required to type in the public password. The words “Dave” and “SW191AA” would resolve to a Unique ID and/or IP address of responsible authentication server supplied by the server (121) using AJAX, and together with the public password provided by the user will be sent back to the authentication server (118) asking for confirmation whether this is the user of this Unique ID. After the website has a positive identification, the Unique ID could be stored in its local database for future reference, dependent on a service provided. For example if it were a web based email service, it could request from the authentication server more user data including but not limited to all names of the user's linked contacts, to dynamically populate the service provider's database. After the user starts sending email to a particular user, an email address of that user would be provided by the authentication server (118). This methodology could enable the user to seamlessly access his own data and third party services or the system itself by using a single access password for all services on the Internet or on other devices including but not limited to mobile phones. A similar method could be used for social networking websites or other online businesses using for example web services and an XML interface connecting to an authentication server.

Note public password is only needed if a device used to access website is not registered with the Unique Entity ID and/or it does not have a short range communication to authenticate user's mobile phone device which will be explained in more details in section Web Access below.

Note that this website's public password does not need to be the same password used by the user to access and change his own data, which may be called a “private password” and should be closely guarded.

This same feature for seamless logging on, via the Entity Name Server could be used using a private password if for example a user has lost his mobile phone, had it stolen, bought a new one or borrowed one from a friend, he could log onto his authentication server and have all his contacts, linked data and other information instantly available.

This allows a user to log on from any other mobile phone. For example if his phone is lost or stolen, that phone may be automatically logged off and access via that device blocked, including access to other services described in more detail below. In the future, if a user changes his own contact data using his mobile device (110) via his authentication server (112), it will notify all linked users about the data change. In this example there is no need for data to be refreshed periodically using data connection (117) to the mobile phone device (116) but only if the user of the mobile phone device (116) tries to open an address book with specific details of the user (110), as it would not be necessary to refresh rarely used contacts, especially if pictures or video is used in the link of such a contact. Otherwise this could significantly increase the data transfer through the data connection (117), but data access speed would be increased, as there would be no need to wait for the authentication server's reply.

In addition any user can remove themselves from another user's contact list at any time should they wish, by removing a link to that user, and similarly a user might withdraw access to any services, data or link objects that he previously granted.

In another embodiment similar to the above described, there is the difference of using only two mobile devices (150, 152) represented in FIG. 1b without a separate authentication server or pointer servers but using a static 128 bit IP version 6 address (which would look like 2abc:0 db8:85a3:08d3:1319:8a2e:0370:7664 but for brevity this document will use only 4 hexadecimal digits). The mobile phone devices (150, 152) will use 128 bit static IP addresses represented with shortened hexadecimal numbers 1a1a and 2b2b respectively. Devices (150, 152) can still publish their data to the Entity Name Server (not represented in FIG. 1b) as they include the authentication server functionality internally.

As in the system represented in FIG. 1a, users will install appropriate software on their devices and register with the service (block 801) before using the system, after which their Bluetooth® name visible to other devices will be Dave@1a1a and Bob@2b2b where 1a1a and 2b2b represent shortened 128 bit IP addresses. The words Dave and Bob are free static text and have no use in the system, but could be used when two users are exchanging files directly to identify one another's devices. Static words could be separated by some reserved symbol like “@” or “#” which could indicate whether a device has a dedicated Internet connection or not. This will be explained in more detail in the next example, as represented in FIG. 1c. In FIG. 1b both devices have a dedicated Internet connection and thus both device names contain the symbol “@”.

As the system in FIG. 1b has no external authentication servers, both devices are acting as authentication servers, where (155, 157) are optional back-up servers synchronised using the Internet connection (154, 156), possibly using the SyncML protocol. For example, the devices may perform methods shown in both FIGS. 8 and 9.

A Back-up server is graphically represented with a symbol such as the one next to the number (157) in FIG. 1b. After both users of the mobile phone devices (150, 152) have pressed the respective bonding buttons on their devices, their respective systems will enable Bluetooth® modules, with the names of the devices set to Dave@1a1a and Bob@2b2b respectively, and write in their local database, data indicating availability to be bonded. As described above, a user input is only one possible way that the method may be initiated. There may be no need to for users to press a button where devices have NFC built in as the process could be started automatically on one or both devices as two mobile phone devices come in close proximity. In the case of NFC there may not be need for step where user selects between multiple users (e.g. by selecting their pictures or user's names provided by their authentication server) as in the short (e.g. five centimetres) range there may be only one device/user. However, the user's name or picture may still be displayed so that the user can confirm the identity of the other device/user before Object (ID) selection.

After the mobile phone device (150) has read from the short range communication (151) Bob's unique ID 2b2b, it will use a dedicated Internet connection (153) to contact Bob's mobile phone device (152 as in block 906) and request further details (including but not limited to a name and picture of the user of the mobile phone device (152)). At this stage, Bob's mobile phone device (152) will be in bonding mode and thus it will reply using its Internet connection (153), with Unique Entity ID, the name and picture of the mobile phone device user (152 as in block 1103) which will be displayed on the screen of the mobile phone device (150) ready for Dave's selection (block 808). After Dave has selected a picture, he will select the type of linking he wants to use (as in block 809) with Bob, i.e. he will select a unique object ID, defining the datasets to be synchronised (in blocks 913 and 1111) between them, for as long they are linked. This information will also be forwarded (block 912) to Bob's mobile phone device (152) after this mobile phone device (152) has read from the short range communication (151) Dave's Unique ID 1a1a it will use a dedicated internet connection (153) to contact Dave's mobile phone device and request further details including but not limited to unique entity ID, name and picture, which once received will be displayed on-screen awaiting Bob's authorisation, or it could be automatically stored in the local database.

After the mobile phone device (152) has read from the short range communication (151) Dave's unique ID 1a1a, it will use a dedicated Internet connection (153) to contact Dave's mobile phone device (150) and request further details (including but not limited to a name and picture of the user of mobile phone device (150)). At this stage, Dave's mobile phone device (150) will be in bonding mode and thus it will reply using its Internet connection (153), with Unique Entity ID, the name and picture of the mobile phone device user (150) which will be displayed on the screen of the mobile phone device (152) ready for Bob's selection (in this simple example with no other nearby devices, the only option will be to select Dave's picture). After selection is made, Bob will be presented with options of types of linking available. After his selection is made this information will be stored in a local database and confirmation of the link created will be sent to Dave's device awaiting authorisation if necessary, after which both devices can disengage bonding mode and synchronise the necessary data set(s) if not synchronised already.

In some instances there may be no data sets, if, for example, the exchanged unique Object ID refers to a link object which grants authorization to access a service or device.

FIG. 1c represents a hybrid system using an external authentication server (174) responsible for a device (170) and a mobile phone device (172) which may function with an internal authentication server responsible for its own authentication (or in another example, it may have a remote authentication server, as in other examples described herein). A user of a mobile phone device (172) is requesting access from a device (170), which could be his company car. Note that the device/car (170) has neither dedicated Internet connection nor direct connection to its authentication server. An optional back-up server is represented next to the number (176).

In an alternative example of the use of such a hybrid system, the user's device may be the device (170) which is without a dedicated internet connection. This user's device may be, for example, a watch or a mobile phone without battery power or network coverage. The device (172) with the internet connection may be an ATM, desktop PC or any other such device. In such an example, the user's device (170) tunnels over the other device's (172) internet connection in order to communicate with its associated authentication server. Another such example is described below.

Before being able to use the system, it needs to be initialised. In this step the device (170) will become related to an Unique Entity ID using the authentication server (174) (described above in more detail), and if using a Unique ID number without an IP address there may be a need for a pointer server.

It is possible to insert a 64 bit number identifying a user, an object or even an authentication server IP in to the 64 bit host part used for a 128 bit IPv6 (or even make it change over time). For recommendations on randomness creation consult document RFC1750 from Network Working Group available at: http://tools.ietf.org/html/rfc1750#ref-GIFFORD and for suggestions about changing IPv6 consult RFC3041 “Privacy Extensions for Stateless Address Auto configuration in IPv6” available from http://tools.ietf.org/html/rfc3041#ref-RANDOM. Noting that a random number generated could be used to identify an entity or a device or used to identify a link between two different entities or devices or, as in this example, it will be used to give access to car. The above references are incorporates herein by reference.

Device (170) could be pre-programmed with access numbers/codes which will be transferred/exchanged using short range communication, (e.g. which unlocks the car). The pre-programming may occur during the manufacturing process or the access numbers/codes could be generated by an authentication server (174) and transferred to the device (170) ‘on-the-fly’ during initialisation.

Additionally, the device (170) could be supplied by the manufacturer or an authentication server (174) with one or more so-called ‘hash keys’ used for data encryption. It might be important to encrypt data from being misappropriated from device (170) using hash functions including but not limited to SHA-1, MD5, or RIPEMD-160 with the hash key supplied, especially if authentication will be via a remote device, in this instance a mobile phone device (172) using virtual authentication by means of tunneling or encapsulation or polymorphism of an identity ID.

The term ‘encapsulation’ is used herein to refer to the situation where multiple pieces of data are included within a single data structure. For example, an identifier for the driver of the car and the car details may be encapsulated within a single identifier.

The term ‘polymorphism’ is used herein to refer to the situation where the actual code which represents the same user/device/entity changes whilst still representing the same user/device/entity. The codes used may change in a sequence which is known to the authentication server. This provides security benefits as anyone who intercepts the code cannot use the code in the future as the particular code has only a limited period of validity or may be a single use code.

However encryption might not be necessary for many uses, as for example access could be granted via the 64 bit host part of an IPv6 number. The system could generate 100,000 random 64 bit numbers, which could be each be used only once to access the service and only one will work at the time i.e. not all 100,000 combinations will give access at the same time but only one, after which their validity would expire. Additionally for security purposes, the device could be pre-programmed to accept only one such number 64 bit host part IPv6 number per minute for every 64 bit network prefix with maximum of, say, 100 trials and errors and thus reduce dramatically the chances of success of a brute force attack.

However to simplify this description we will use the model in which the IP address of an authentication server associated with the device and the Unique ID are inserted in a Bluetooth® name. Specific IDs could be pre-programmed into the device (170) to unlock the car on once-only bases, with expiring times, thus eliminating the need for encryption of the data between the device (170) and the authentication server (174).

In the future new data fields may be created by hardware or software manufacturers of short range communications (Bluetooth®, WiFi, IrDA, RFID, NFC etc) modules for the specific purpose of passing a Unique ID between devices. One of the characteristics of the new field would be a very fast discovery of near-by device.

In addition to the initialization described above, the device (170) and the mobile phone device (172) will be linked (i.e. device (172) will have access to (170) which will be stored on authentication server (174) database), prior to full use of the system, as will be explained in more detail in the section related to the “Business/Charity link” below.

Both devices (170, 172) may be using 128 bit IPv6 and a naming convention of four hex decimal numbers abbreviation for each 64 bit part of 128 bit IPv6 address, with the addition of the host part of the IPv6 address. The mobile phone device (174) and Bluetooth® name will be set to John@1c1c.5c5c where “@” indicate the internet connection, 1c1c is the 64-bit (sub-) network prefix of IPv6 address of the mobile phone device, in this scenario, included on device the authentication server (172), and where 5c5c is the 64-bit host part of IPv6 address set to be Device ID. The device's (170) Bluetooth® name will be set to Car15#2c2c.8c8c where symbol the “#” indicates that there is no Internet nor direct data connection to an authentication server for this device, 2c2c is set to be the 64-bit (sub-) network prefix of IPv6 address of an authentication server (174) and 8c8c is the Device ID identifying the device (170).

Upon searching for nearby devices, the mobile phone device (172) will read the Bluetooth® names available, in this instance it will discover Car15#2c2c.8c8c, and at the same time the car's Bluetooth® module will read John@1c1c.5c5c and remain locked.

After this step, the user's mobile phone device (172) will parse text from the Bluetooth® name, and recognise the symbol # (meaning that specific device—in this case the car—has no internet connection available), so it will use its own connection to contact the authentication server (174), using the extracted IP number 2c2c and 8c8c Device ID from the Bluetooth® name and of the device (170), and provide its own IP address 1c1c and Device ID 5c5c (or Unique Entity ID related to this device) of the Mobile Phone Device (172).

After the authentication server (174) has positively confirmed an authorised link between the user of device (172) and (entity in control of) the device (170), it will issue one of the unique numbers (unlocking keys) 1f1f in this instance programmed in to the device during initialisation or registration, which will unlock the car once only.

Upon receiving this number, software on the mobile phone device (172) will rewrite the Bluetooth® name for the device to be John@1c1c.1f1f which, when read by device (170), will result in unlocking the car.

Additionally after this step, device (170) could change Bluetooth® name according to a pre-arranged scheme (established at initialisation) so the next time new values are past to the authentication server it will be updated accordingly with information on who or which unlocking key issued by authentication server (174) had previous successful access using that unlocking key, effectively guaranteeing only one device ID (unlocking key) at the time can unlock device (170), and for administration purpose so authentication server (174) can store data identifying which user at which period of time has accessed the device. For further security this cycles of exchanging unique Device IDs could be repeated.

Note that authentication server (174) will identify original 8c8c Device ID as one before 1f1f—which is the next unlocking key, thus although there could be 100,000 64-bit unlocking keys (codes) pre-programmed to device only one at the time in sequence will unlock device depending on previous Device ID.

Above example is with a “static” list of unlocking numbers while even better a “dynamic” solution is described below. The solution would randomly generate unlocking keys on-the-fly and very often change it through the time as it can be repeated infinitely for added security. For recommendations on randomness creation consult document RFC1750.

The solution could include an algorithm including but not limited to SHA-1, MD5, or RIPEMD-160 and a hash key (randomly generated unlocking key) as it would take less memory on the device and less data transfer during initialisation than a long list of for example 100,000 unlocking keys and it would be an infinite source of unlocking keys. Additionally every unlocking key could be time expiring.

For example if there was no authentication server (174) and device (170) is trying to get access to device (172) than both devices would set Bluetooth® names as Device170#8c8c and Device172#5c5c where 8c8c initial Device ID for device (170), and 5c5c initial device ID for device (172).

Both devices (170,172) will use the same SHA-1 algorithm and device (172) has generate random Device ID (5c5c) as result of combining a noise random generated number (also used as unlocking key in this example) (1f1f) and SHA-1 algorithm. Noise random number could be easily generated from number of sources including but not limited microphone camera, hard disk etc.

Once device (170) gets number (5c5c) it will use the same SHA-1 algorithm and resolve it to (1f1f) initially generated on device (172) using noise random generation number. Upon setting this number as Bluetooth® name Device170#1f1f and once it is read by device (172) the device (170) will be granted access.

A similar method to that described above could be used in an example where (172) is a cash point terminal with own authentication (bank's) server included inside and linked to a Unique Entity ID on authentication server (174) using random generated number from the noise using the same hashing algorithm as device (170), and where device (170) has no dedicated access to the internet but would like to access the service provided by cash point (172). After the cash point terminal (172) has read Unique ID of device (170) which includes an the IP address of an authentication server responsible for device (170) and device ID, it will forward device ID to the authentication server (174) to positively identify Entity ID using this device ID. After receiving the Entity ID the built in authentication server (172) will check if user is authorised to withdraw cash using the cash point with built in authentication server (172). If the user is authorised, the user may be asked to confirm short PIN before money is dispensed, and the PIN might in different scenarios be entered via device (170) or via device (172). As described above, the cash point (172) may alternatively not comprise an authentication server and may alternatively use its internet connection to access a remote authentication server.

In another example, the methods described above in relation to FIG. 1c may use multi-threading of an identity, by which multiple users may be issued different keys to access a particular other device. In the example of unlocking the car given above, multiple users may each be allocated a different key to enable it to unlock the device. Similarly, multiple users may be able to bond with the ATM using the same device but different hashing algorithms and unique IDs.

Although in the previous section for describing the system the term “user” is used, the same automated process could be used to bond with a number of different services and entities. An example is in relation to bill-board adverts 100 meters away using a WiFi wireless connection. After bonding, the relevant advertising company should be able to contact the user through a medium that the user has selected (E.g. from email or phone etc), and the user should have all the necessary information to contact the advertised company and to access other data including but not limited to promotional videos etc. There is no need for the billboard to have a dedicated internet connection to its own authentication server as it is used only to distribute/initiate bonding. While real process could be completed between user's mobile phone device and a remote authentication server connected to the internet and related to Unique ID distributed by the billboard.

Examples of uses of the system are numerous.

The system mentioned in FIG. 1 has a limitation of only one pointer server storing and serving all system users, which would make it in practical terms at worldwide level very difficult to run, even with sophisticated and distributed load balancing. Additionally some organisations including but not limited to governments or large businesses will be unwilling to share such internal information as BD_ADDR/BSSID numbers for bonding between two devices/users which could (although very remotely) identify two people/personnel bonding together. The proposed solution to such problems is shown in FIG. 2 which adds a multi-layer system providing a top-level server(s) for the whole world, with second level servers associated with countries, regions or continents, and then lower level servers for organisation including but not limited to governments, firms and service providers (and so on as needed). In such instances the bonding process would be achieved locally and only if the BD_ADDR number is not registered locally, the system would progress a search or registration one level up. This process continues until the server with knowledge of the BD_ADDR number is found, or the top level server replies that no such BD_ADDR number is registered.

Additionally to relieve strain on the pointer servers and to increase the speed of authentication, especially for access, it would be essential (where access is granted) to store the data locally on device level and periodically update a database of all authorised BD_ADDR numbers of authorised users or devices. Ideally this should be implemented using an electronic memory including but not limited to high speed RAM, rather than using hard disks with slower access times. For example in public transport each bus connected to the system should hold locally a database of all users who can use this bus transport system, rather than waiting for the authentication server's reply.

FIG. 2 shows a simple representation of such a system where a smaller system (200) similar to that described in FIG. 1 is contained inside of a larger system, maintaining integrity of the system but preserving all data transfer between its users locally and reducing the strain on the larger system. The smaller system (200) is described above, but if a BD_ADDR number of a mobile phone device (207) is found by a device (116) and not located using a pointer server (114), then using an XML connection (202), the pointer server (114) or the authentication server (118) will seek identification from the pointer server (201) and if found, the server (201) would reply with at least the IP address of the authentication server (204).

Upon receiving this information, the authentication server (118) will contact the server (204) asking if the relevant user related to BD_ADDR is available for bonding. If so, it will receive the user name and/or picture or other data, which will be made available to the user of the mobile phone device (116). Once the user of the mobile phone device (116) selects on which level bonding should be made, (including but not limited to private, business, hobby etc) this information will be passed to a server (118) which will write selection to the database and send data to the authentication server (204) making it available for the user of mobile phone device (207).

The same process as above would be repeated by another user to enable a user of the device (116) to access the data of the user of the mobile phone device (207). After successful exchange of Unique IDs users/(devices) and/or their authentication servers, will synchronise data and update mobile phone devices. Note that this process was described in more detail previously but for the sake of simplicity, this example was kept short.

The system mentioned above has no limit when adding new pointer servers using the methodology described for pointer servers (201, 114). Thus there could be a multitude of levels including but not limited to world, continent, region, government, company, city, network provider, and all coexisting in the same distributed environment, thus preserving the data of users.

The above described system is a simple example of bonding between only few people exchanging contact details directly, but it is possible to have the same principle of bonding between different people and entities and machines for many different uses as will be described below. Note that for sake of simplicity, not all details will be repeated in every example but generally only the ones which are characteristic for each particular case, while the principles of user/entity registration, de-registration and searching etc will remain the same.

In a further example, two devices (or the entities associated with the devices) may be registered with the same authentication server with a single service for example to share a Private Profile. In such an example, the devices may link without using an IP address of the authentication server or an Object ID or other identifier for a data element. In such an example, each device has a long range communication connection to the authentication server and when the devices come into close proximity, they exchange their Unique IDs via a short range communication connection between the two devices. At least one device then sends the other device's Unique ID to the authentication server via its own long range communication connection. On receipt of a Unique ID associated with a second device from a first device and/or receipt of a Unique ID associated with the first device from the second device, the authentication server creates a link/bond between the first and second devices and/or entities. This may cause information or objects to be made available to the devices or entities. Additionally, before the link is created, a confirmation request may be sent from server to devices via long range communication connection, and a confirmation received in return.

If multiple authentication servers are used than use of IP address within Unique ID might be necessary.

In some examples, an entity associated with a device may define the type of link that is created in this manner (e.g. where no ObjectID is specified), e.g. a default ObjectID or the type of link may be determined by the authentication server.

Whilst most of the examples described herein refer to sharing of data or receiving access to data following authorization and establishment of a link/bond, in other examples in addition to receiving access, or instead of receiving access, an event or a sequence of events may be triggered. This event may, for example, be, or may trigger, a mechanical, electronic or other action, performed by device, remote device, another device, a system, an object or an entity. For example, the event might be opening a lock, executing program code, displaying information, performing a business process, or performing a sequence of steps in other systems, such as executing a money transfer, verifying the identity or authenticity of an entity, performing a credit check, applying for a new service, or issuing documents.

### Applications

Business Link (Exchange Link)

This section will explain how an employee could get additional own employment contact data (including but not limited to a business name, telephone number, address etc) from a new employer. This could be distributed to other business people during the course of normal day to day business. Additionally a company which has issued an employee business contact data could decide, and issue a policy, to keep some or all contact data made during employment, if for example the employee was employed as a sales representative. Additionally an employee could simultaneously get access to the company's office, desktop and/or car etc.

In this example the system is without a pointer server thus there is exchange of at least the IP address of the authentication server responsible for the device using short range communication preferably included in Unique ID.

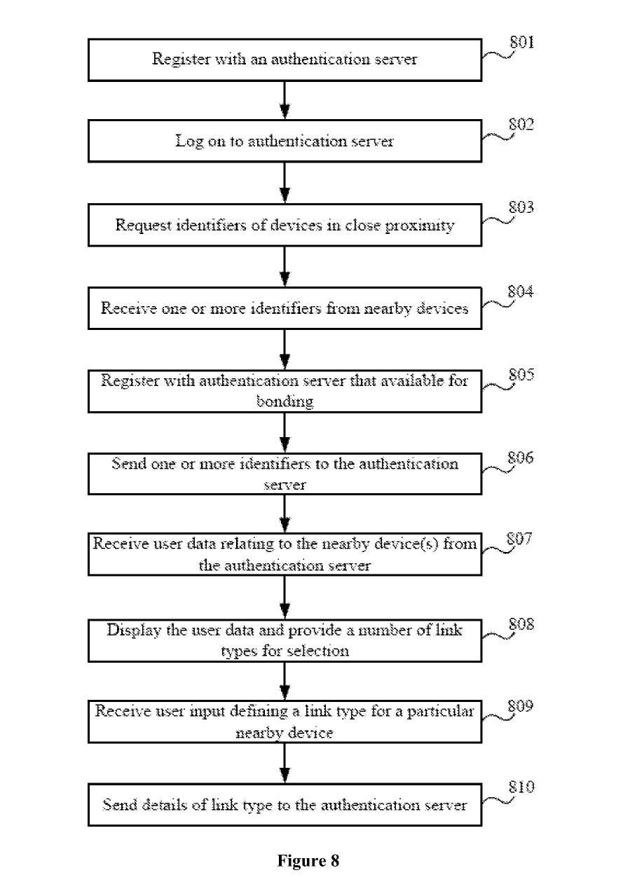

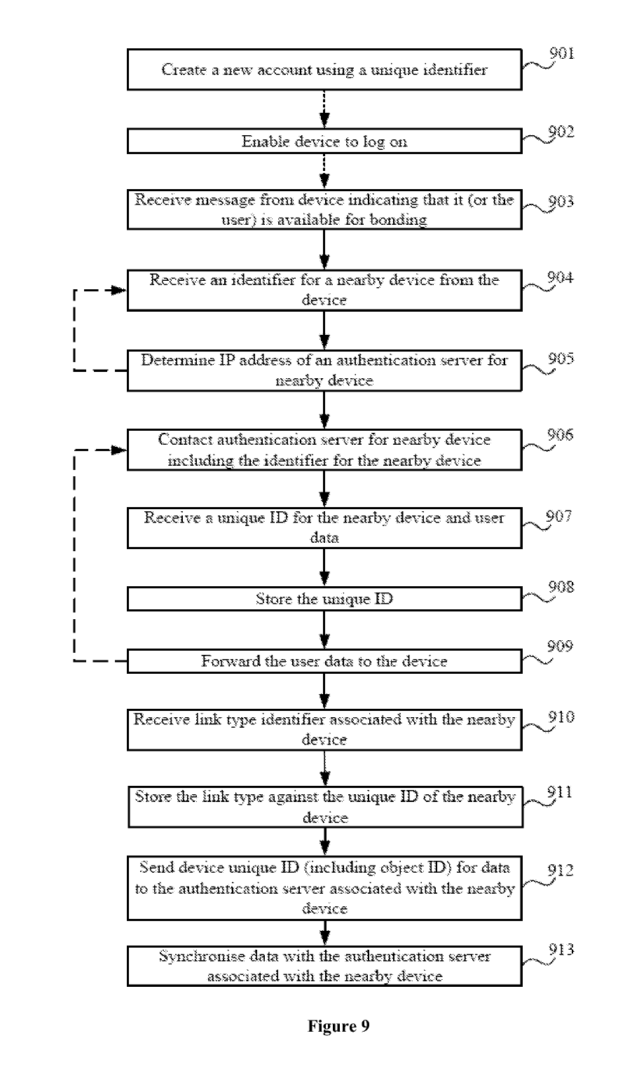

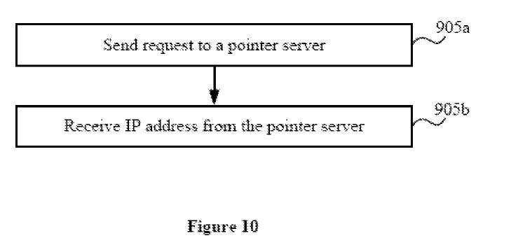

Before using the system, all three users will register for the service to their respective authentication servers, thus creating databases populated with information represented therein. Examples include user John in FIG. 5, rows next to the numbers (501) for Private and Public passwords and a bonding tag, for a mobile phone device (502), car (503), home (504), name (510), phone (511), email (512) and then defining a Private Link (555) by grouping previously entered information. Creation of the rows next to the numbers 556, 561 and 562 will be explained latter in the document. Similar methodology will be repeated for users of the databases represented in FIGS. 6 and 7.

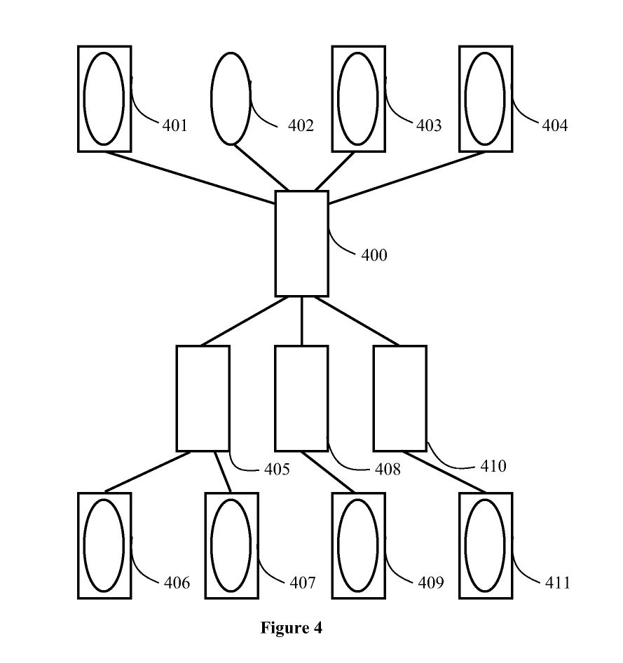

Initially an employee will register at his company's security office, using his mobile phone device (318) as in FIG. 3. At the company's security office there is provided a desktop computer (323) with a Bluetooth module for short range radio communication (322) used for exchange of a Unique ID between an employee's mobile phone device (318) and the desktop computer (323). Additionally the mobile phone device (318) and the desktop computer (323) are connected using the Internet to authentication servers (316, 314) respectively which are further connected together via an internet connection (315).

The unique ID in this example contains a 32 bit IP address of the authentication server responsible for the device, a Unique User ID and an Object ID.

For example if the IP address of the authentication server is 123.123.123.123, the User ID is 55, the mobile phone device Object ID is 01 and the user's name is John, his Bluetooth® name could be set to John@1231231231235501. Note that port number or other information could be added using the same methodology. The name before the @ symbol could be anything (as chosen by the user) and is not used by the system. Also Object ID and User ID could be the same and if there is a single user per authentication server IP address the Object ID could be omitted. The number after the @ symbol becomes a Unique ID which could be further compressed by encoding a hexadecimal number of an IP address and possibly of a User ID and an Object ID for this particular server and/or database or even using alphanumeric coding from some character set for full use of all bits available in every byte.

Pressing a specific button for linking (or choosing an option) on the mobile phone device (318) will activate the Bluetooth® module, setting the device name to John@1231231231235501 and be visible to other nearby devices. After this step it will start a search for other nearby Bluetooth® names. After the mobile phone device (318) has collected Bluetooth® name(s) in this example BigBusiness@1001001001008005 (where 100.100.100.100 represents the IP address of the authentication server (314), the number 80 identifies the entity on the authentication server (314) and 05 is an Object ID for Security Desktop 8 (322), it will then request from the authentication server (314) the name and possibly a picture of the entity behind this unique ID.

If the desktop (323) has indicated to the authentication server (314) that it is available to be bonded by inserting a tag <BOND> in the row next to the number <706> in FIG. 7. then the company name, desktop name (in the case that there are more than one available in the same office) and possibly company logo will be returned to the authentication server (316) and forwarded to the mobile phone device (318) or it could be directly forwarded to the mobile phone device (318), upon which successful completion, it will be displayed on the screen of the mobile phone device (318) ready for selection.

The same steps from the above paragraph will be repeated for the desktop (323) upon which successful completion, the name and picture of the mobile phone device's employee/owner (318) will be displayed on the screen of the desktop (323) ready for selection.

After the employee using the mobile phone device (318) has selected the name and possibly company logo on the screen of the device resolving to Unique ID 1001001001008005, a new screen will open with a selection of predefined link types. In this scenario the employee will select “Private Link” which will result in a Unique ID 10010010010080?? being stored in a row next to the number (555) where “??” represents any number. Thus any object from this particular entity could access information inside next to the number (555) object, resolving in this particular example to the Name, Private Mobile Phone Number and Private Email Address of this employee. If there is need to restrict access to only a particular object from the requesting party this could be implemented by specifying the Link Object ID numbers via authorisation control.

This unique ID 1231231231235521 will be sent to the authentication server (314) and then forwarded to the desktop (323) awaiting the security officer's approval. Once approval is granted, a new row in the database on the authentication server (314) will be created next to the number (777) with a Unique ID 1001001001008055 and a Unique ID 1001001001008021 stored in the “Data” column of the database, thus making a link between those two objects which could have their contact data transferred or synchronised as necessary. At this stage the employee's authentication server and mobile phone device could be notified of a successful link creation.

After this step a security officer will select the employee's name and possibly picture resolving to Unique ID 1231231231235501, and additionally the type of linking—in this case “Executive Business Link”, which will result in the creation of a new row next to the number (781), creating access rights for the desktop 12 placed in the office, the Company Car 15, access to the company's building and all doors necessary for the employee to do day-to-day business, and permissions for access to a company parking place by populating the database column “Linked/authorised” with the relevant access Unique IDs in the “Data” column and the Unique ID from the employee's mobile phone device (318) Bluetooth® name 1231231231235501 which will be stored in the column “linked/authorised”.

Additionally a Unique ID 1001001001008021 pointing to business contact details will be created and sent to the employee's authentication server (316). Note, the company's policy in this scenario is to hold any contact data the employee has gained during normal business duties in the name of the company, and to withhold such data. As a result any business data or contacts/links gained are stored on the company's authentication server (314). In practice the tag <OWN> could be inserted in the request body so that the authentication server (316) can place the Unique ID together with other links used to link with other entities including but not limited to “Private Link”, “Business Link”, “Hobby Link” etc. Once approved by a user of the device (318) this will be stored in the row next to the number (556) and authentication server (314) and desktop (323) are accordingly notified of success.

At this step or afterwards, data can be transferred and/or synchronised as necessary between the employee and company, and both the mobile phone device (318) and the desktop (323) remove themselves as devices available to be bonded, on their respective authentication servers.

Another feature of this example will be that once the employee has been granted credentials or access rights from the company it could automatically enable him to access company's desktop computers, unlock automatic doors of the office building or office or even use a company car with a module which is connected to the internet (for an example without the internet connection please see FIG. 1c description) in the same fashion as any mobile phone device is connected to the authentication server and a Bluetooth® module name used for authentication in conjunction with an electronic central locking with a Bluetooth® module and connection to an authentication server. An example of business access for the registered user above will be briefly described below.

In this example the same FIG. 3 will be used, but with a different purpose, when a registered employee, using a mobile phone device (318) comes in a close proximity of a company's automatic doors (323), which has a Bluetooth® module for short-range communication (322) and an intranet connection (324) to the authentication server (314). The mobile phone device (318) will have its Bluetooth® module constantly active, and its name visible, as described above, and the automatic door (323) in this example will constantly send a request for discovery of any nearby devices in the range of 10 meters. Upon receiving any new Bluetooth® names (Unique IDs) it will search a local database, and if not found, it will request from authentication server (314) authorisation, and if granted it will unlock the door.

Authorised Unique IDs could be stored locally to the electronic door so that the access time is lower, however it may be synchronised periodically so that the database is refreshed if an employee has lost a mobile phone or if employment has been terminated or on non payment of fees (in an example of public transport). Additionally, periodically the authentication server (314) could request periodically from another authentication server (316) that the data is still correct and this Unique ID is still registered against a particular user or entity. This method is called “pull”. Another preferred method would be that if there is any change, for example the user's mobile phone is stolen, in which case the authentication server (316) would notify immediately authentication server (314) to remove Unique ID permissions immediately from its systems.

The second part of this scenario will be described by way of an example of exchange of contact details between two user's (John and Joe) using FIG. 3 as a schematic of the embodiment and FIGS. 5, 6 and 7 as simplified versions of their databases.

Both users of mobile phone devices (318) and (310) have their Bluetooth® names set to John@1231231231235501 and Joe@0990990990994001 respectively are using the same naming convention as before and in the case of John the same database represented in FIG. 5. In this example John & Joe are pre-registered with respective authentication servers (316) and (312).

After both users have clicked the bonding button (or choose an option) on respective mobile phone devices their respective authentication servers will register this information by adding the tags <BOND> in the fields next to the numbers (501) and (601) respectively.

Separately both devices will collect nearby Bluetooth® names and send them to their respective authentication servers which will, in turn, contact each other with expectation of receiving a name and possibly a picture of the respective user.

Once the names and possibly pictures are received, they will be displayed on devices, upon which users will make a selection. Immediately after selection of the particular user on the screen another screen will open asking for the type of linking, where the user of the mobile phone device (318) will select the “Private Link” or “Business Link” options. Accordingly this information will be sent to the authentication server (316), which will send the Unique ID 1231231231235521 and the unique ID 1001001001008021 to the authentication server (312) using the internet connection (325).

Note that the unique ID 1001001001008021 points directly to the company's authentication server (314) as a result of company's policy and the authentication server (316) will send a request to the business authentication server (314) to enable the user of the mobile phone device (310) with unique ID 09909909909940?? to see his business contact data, which results in the Unique ID being added in “Linked/Authorised” column in the row next to the number (720). After employment of user of mobile phone device (318) has terminated, the company will continue to have access to critical data including but not limited to contacts that the employee has made during the employment such as contact details of Joe in this example.

Upon receiving these two Unique IDs, the authentication server (312) might send it to the mobile phone device (310) for authorisation and if granted, it will create two rows next to the numbers (661) and (662) and populate them with respective unique IDs received.

After the user of the mobile phone device (310) has selected a name, a picture and a type of linking (in this example Private Linking) Unique ID 0990990990994021 will be sent to the authentication server (312), then forwarded to the authentication server (316) and then might be forwarded again to the mobile phone device (318) for authorisation. After that authentication server (316) creates a row next to the number (562) and storing the Unique ID 0990990990994021 in the “Data” column.

After all the steps are completed, the devices will be removed from bonding mode, and all necessary data transferred if it is not already.

Note that the above principle of linking is designed with separate database rows for incoming and outgoing link, thus making it possible for one of the users to delete an incoming contact link of another user, but still stay visible to another user through outgoing link. Whereas if there was only one row for incoming and outgoing connections, then deleting from each end would terminate both links. So a link or relationship between two users sharing contact details can be also seen as two one-directional links, or two separate decisions to share own details with another person.

Currency Transfer Between Two Users Who have Never Met, or are Already Connected

This section explains how currency or other information could be securely exchanged between two users. Note that as it will be apparent from this example, currency could be valid between only two people or world-wide only depending on user's choice and trust.

After registering the first user Unique ID using the mobile phone device (318) in a Bank's branch against his bank account using methodology previously explained, where his bank account becomes an object related to bank and this particular user, a user may exchange currency, information or transaction instructions. In this scenario the bank's desktop computer (323) has a Bluetooth® module for short range communication (322) and an Intranet connection (324) to the banks authentication server (314).

After registration, a user can deposit cash, which will be registered against his Unique ID in the bank using an authentication server (314) and a database attached to it. The same process will be made by a second user of a device (310). It is important to note that the process of registration in the bank, as described above, will add a Unique ID pointing to the bank's authentication server, to a mobile phone device (318) and (310) and their respective authentication servers (316) and (312) similar to a business link or private link but which will never exchange any data (including but not limited to a bank's account name or details), between individual users when selected, but instead will point the mobile phone device(s) to a bank's authentication server for verification and authorisation. So every user could have multiple Unique IDs, each relevant for another service and meaningful only to the relevant authorization server. Together with unique ID, a Service ID could be exchanged, to specify the desired link type or authentication. For example specific banking or payments Service ID will always invoke only registered bank accounts from which money could be transferred, and not other link types (invoked by other Service IDs), such as contact detail exchange. In this example for sake of simplicity a single bank is used but in practice it could be a network of inter-linked banks.

After two users of mobile devices (318, 310) who have never met before, come in close proximity, they will be able to press a button on mobile phone device which will make their respective devices available for bonding—in this case to enable currency transfer, which will update their status on authentication servers (316) and (314) respectively. As a result they will be visible to mobile devices in close proximity using the previously explained methodology for bonding between two users. However once the users come to the option of selecting link types including but not limited to Private, Business, Charity, Hobby etc, there will in this case be a Bank's link type as well if banking Service ID was not exchanged in which only banking/money transfer services would be invoked.

If exactly the same bank and/or network of the banks is selected as default by both users then for example a street newspapers seller could have his mobile phone device always in receiving mode with a specified amount and newspaper reader could have his device in sending mode for a very fast transfer which would occur by just bringing two devices in close proximity. Otherwise another screen on a display of a mobile phone device (318) will open requesting to enter, or confirm, an amount to be transferred and optionally a password for larger amounts. Once this step is completed, data will be sent to the authentication server (316) which will forward a unique (entity) ID of the recipient collected by Bluetooth or NFC using methodology previously explained, unique (entity) ID of sender a password (if required) and an amount to be transferred to the bank's authentication server (314). Thus requesting to transfer the amount of money as specified by the user of the mobile phone device from the bank account of the user using mobile phone device (318), to the bank account of the user using mobile phone device (310) which could be found from their respective Unique IDs collected during the bonding procedure and resolved to unique entity ID using authentication servers as described previously. Bonding procedure for one off money transfer could be temporary, i.e. as soon transfer is completed bond is deleted.

At this point, other checks and steps may be carried out by systems of the bank or other entities, like a balance check or a credit check. If there are sufficient funds, the money will be transferred to the bank account of the user (310). In practical terms this means triggering the necessary steps in the bank's systems to transfer money, and recording the transfer in the bank's database, after which, both users could be sent a notification. Note that it is possible to have both mobile phone devices (318, 310) pointing and dealing directly with the bank's authentication server (314), for speed of transfer using a data connection (318) but this is a less secure option.

The above example is for users who have never met before, but another principle would be to select anyone from a phone book and then choose the option to transfer money. At this stage, a mobile device (318) will send data including an amount of money to be transferred, a recipient's unique ID (from the phone's contact links) as well as any own authentication data necessary like unique entity ID for the transaction (including a password if necessary), for the Bank's authentication server (314) via user's own authentication server (316).

In all examples above and below additionally every request should be double-confirmed (backwards to originator) with respective user's authentication server, and the mobile phone device requesting the transfer, before allowing the transfer so that unauthenticated requests with false Unique (Entity) IDs may be avoided. This is due to the fact that short range communication and node device could be manipulated but not the entire internet network.

### Identification Between Two Users by a Third Party (Police ID)

On the same principle as above, where two mobile phone devices are pointing to a third party authentication server, it is possible to verify the identity of a mobile phone device user. For example, one person could be a resident of a particular country using a mobile phone device (318), and a second person could be a police officer using a mobile phone device (310), where after both resident and police officer have pressed a bonding button on their respective devices, and selected a ‘Police Identification link’. This would result in both authentication servers (316, 312) changing the status of their users, in this case the resident and police officer, to be available for this type of bonding, and consequently both pointing to a police authentication server (314).

The police officer's and the resident's images and names would be revealed during the initial bonding stages where both participants could select each other's identities to see more details. As a result, the resident would see identification of the police officer, and the police officer would see identification details and other information of the resident supplied by the authentication server (314). It would be impossible to forge this, as both devices would be pointing to the same trusted server, in this case the police authentication server (314) preset in advance with the resident and the police officer using methodology previously explained.

In another scenario, still using FIG. 3, a similar principle could be used for passport control, where a desktop computer (323) would automatically collect Bluetooth® names of mobile phone devices (310, 318) of a border control officer, and a citizen crossing a border respectively. On prompting by a border control officer, a desktop computer (323) would unlock and display relevant information for the border control officer, and available to a government authentication server (314) for a particular traveler, including additional authentication information (which may be biometrics including but not limited to iris scans or finger prints) if necessary.

### Web Access

In yet another example it will be described how the same system could be used to provide automatic secure access to a website (for example of some bank with additional security), potentially eliminating any need for logging a username and/or password (unless a very large amount of money is being transferred, where an additional password or biometrics might be requested for an additional security).

Once a user of a mobile phone device (318) has come into close proximity of a desktop computer (323) in an Internet coffee shop with a Bluetooth® module enabling short range communication (322) it will be possible for the desktop computer to collect the Unique ID of mobile phone device (318).

At the same time, a user could press his respective bonding button, and select a desktop he wants to connect to, the Unique ID of which will be sent to his authentication server (316). From this point if the request comes from the Desktop's (323) or authentication server's (314) particular Unique (User/Entity) ID to the authentication server (316), it will confirm with the mobile phone device (318) whether it is still in close proximity of the desktop computer (323). If so, it will return positive confirmation. If not, it will stop providing any further confirmations to the authentication server (314) and return negative confirmation.

Once a user connects to a secure bank's website running for example 128 bit SSL (or other) encryption where a local script is executed on the desktop computer (323) (for example Active X or some other technology), it would request Bluetooth® names containing Unique IDs of devices in close proximity, in this instance a mobile phone device (318). Upon receiving the Bluetooth® name it will be sent using Internet connection (324) to a bank's web server and authentication server (314). Upon parsing the IP address of the authentication server (316) from the Bluetooth® name, the authentication server (314) will use the data connection (315) to request from the authentication server (316) to positively identify that mobile phone device (318) as being in close proximity of the desktop (323) and having this Unique ID and return unique entity ID if different from unique ID.

If the user is in close proximity of the desktop computer (323) and is positively identified with a Unique Entity ID the same as a previously registered user for this service, the secure website would automatically unlock. Once a user has left the desktop computer, and his mobile phone device is not in close proximity any more confirmed by mobile phone device or desktop or both, the bank's secure website would automatically restrict access to some or all of its functionality.

### Election Functionality

In yet another example it is possible to have an election within a company or on different government levels including but not limited to local, country-wide or internationally.

Once each citizen has registered their details against a unique entity ID and an authentication server IP address has been linked to a government authentication server, (which could be used additionally by other government bodies such as police or passport control) it is possible for the authentication server (314) which is part of a government to send or push an election question to registered citizens' mobile phone devices (318, 310). Upon receiving the election options or questions they could reply directly to this authentication server (314) (or more securely via authentication servers (316, 312) respectively).

If the authentication server (314) has positively identified a user's current Unique Entity ID as previously registered for a citizen using the particular Unique Entity ID registered with the government authentication server (314), their vote or reply would be accepted.

Peergroup TV—mp3/mpg4 to Home/Business, Music/Video Handover

This section will explain how any home or business desktop computer or screen including but not limited to a TV or display may be linked with any remote storage device, (for example for storing pictures, music or video or any other content) and connected via the Internet or an intranet.

Firstly, before use, a remote video storage device needs to be uploaded with video content, and linked to a user's Unique Entity ID stored on an authentication server database (316). Typically a link on the authentication server (316) side would include an IP address of a remote storage server database (312) if it were not the same as the authentication server's IP address, and any additional logging information as necessary. Additionally this could be added to a list of a user's own link types (including but not limited to Private, Business, Hobby etc). The difference is that by selecting, for example a Video link, no contact data need to be exchanged with a receiving party as with a Business link, but there could be a time limit to restrict access with other bonded devices using this link.

Once a user's remote Video storage is defined and a Video link added to a user's list of own links on a mobile phone device (318), this user would be able to press one button while at his colleague's home and see his colleague's networked TV (323) in the list of devices available to be bonded (as this TV is always in bonding mode waiting for the specific type of bonding as explained above). Please note that the TV (323) is connected to the Internet and the authentication server (314), where the TV is linked to a unique entity ID of the owner of the premises (in this case a colleague). The TV has a Bluetooth® module enabling wireless exchange of Bluetooth® names using short range communication (322).

After selecting a colleague's TV (323) from the list of available devices on mobile phone device (318), a user might select the relevant Video link type on the mobile phone device screen, which will result in a request to the Authentication server (316) being sent using a data connection (317). The request will include a Bluetooth® name (Unique ID) of the TV device (323) as well as a Video sharing Link request. Upon receiving this information, the authentication server (316) will request from the authentication server (314) to issue a temporary access for the TV (323) for the user of the mobile phone device (318).

At the same time the authentication server (314) will confirm with the TV (323) that the mobile phone device (318) is in close proximity using the Bluetooth® name (Unique ID) of device (318) and additionally confirm with TV owner if it is OK to allow user of mobile phone device (318) access.

If positive confirmation is received, the authentication server (314) could connect directly to the Video database (312) or via the authentication server (316) (which is overseeing the authentication process to restrict content).

Once the authentication process is finished the authentication server (316) can pass Video options and Video stream handling directly to the TV (323). At this stage all options including but not limited to choice of video to be played could be commanded from the TV remote control or from the user's mobile phone device (318) or TV owner's mobile phone device. Periodically the authentication server (316) will check if the device (318) is still in close proximity of the TV (323) and, if it is not, authentication could be terminated and all access to Video content interrupted.

A similar principle could be used on a networked mp3/mpg4 player with an Internet connection and Bluetooth® or a home/car/business music/video system with an Internet connection and Bluetooth® module, where once a listener of an mp3/mpg4 player walks between home, car and office there would be an automatic switch over of music or video played on the home, car or office music or video system from a remote music or video database, using all necessary authentication servers as described previously.

### Advertising

In yet another embodiment it is possible to connect a user of a mobile phone device (318) to a company advertising some product or service using (for example a large advertising billboard) with a WiFi module (323) with a range of up to 100 meters, and an Internet connection (324) to a remote authentication server (314).

In this particular instance it is also possible to do without a direct Internet (or other) connection (324) to the authentication server (314) and the billboard (314), as the billboard does not need to store locally any information about the user interested in the particular advert. The only purpose is to distribute the Unique ID for this billboard, which at a particular time is related to a particular advert and unique entity ID of advertiser on a remote database stored on an authentication server (314).

After seeing an interesting advert in the distance, a user will be able to press the appropriate button on his device to initiate a bonding process and select the name of the advert, or even see a picture or video on their mobile phone device (314) identifying the advert. After this step the user will be able to select a link type, (for example Private) which will cause his mobile phone device's WiFi module to request unique addresses (BSSID numbers or SSID names) of nearby devices, which once collected will be transmitted, as well as user's selection of Private link type to the authentication server (316) using the a data connection (317).

Upon receiving this information the authentication server (316) will request from the authentication server (314) an exchange of contact details for a Private link. After this is complete the advertised business will have the contact details of the interested user including but not limited to his mobile phone number for SMS, MMS or Video communication attached to his Private Link and the user will have data added to his links including but not limited to the company's website URL, telephone number and/or promotional video for more information. The user can at any time change his preferences on how he wants to be contacted by the particular company, (for example by email instead of by SMS), or they can withdraw their consent to be contacted at any time.

### Centralised User Login to the System and Connections to Other Web 2.0 Services

The FIG. 1d shows a schematic of the system according to another embodiment, where centralized server is used to login mobile devices thus IP address of authentication server is not necessary to be exchanged between devices connected to the same server. Elements 183, 184, 185 and 186 represent mobile phone devices which may exchange unique ID (even without IP address of authentication server) using short range communication (182) after users have registered and logged in to the system using the internet connection (181) and the authentication server (180).

Additionally users could be linked to other Web 2.0 services using publicly available APIs or other means of connection to other services, for example a social network (188), web email (189), instant messenger (190), blog (191) and file sharing (192) using the internet connection (187). This would allow data sharing between different services and authentication server (180). For example contacts could easily be synchronised between different services by user simply clicking a service he/she would like to add on his mobile phone after which user may be diverted to a web service of such provider to further authorise such service. In this way user could allow his/her data sharing while not providing their username and password of third party service (188 to 192) to a company providing authentication server (180). For example such system could, as soon as two people create a link between them using short range communication (182) or otherwise, automatically populate database of other service provider e.g. web email (189).

### Logical Connections Between the System User and Devices

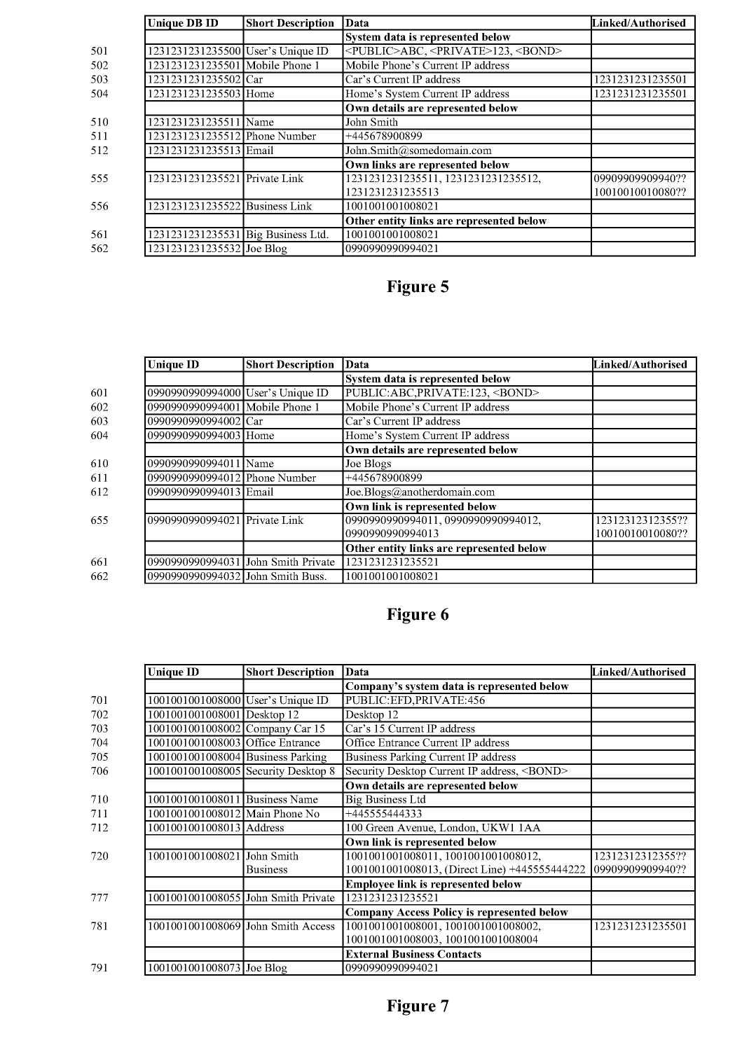

FIG. 4 represents an example of possible logical and physical connections between a user and other devices through a network of authentication servers.

Authentication server (400) holds the data about the user and his directly related devices (401, 402, 403 and 404) which are directly linked or registered to user's Unique Entity ID and additionally linking or pointing to other authentication servers (405, 408 and 410) and their devices (406, 407, 409 and 411).

In one embodiment the device (401) could represent a user's desktop computer connected to the Internet with Bluetooth® and/or WiFi module, a mobile phone device (402) connected to the Internet and with Bluetooth® and/or WiFi module, as well as further examples (private house access (403) with CCTV, Security alarm, centralised heating and air-condition, electronic door locks etc), each connected to the Internet with Bluetooth® or NFC modules placed at particular places. Another examples is private car access (404) with electronic locks connected to the internet using for example standard mobile phone technology to connect to authentication server (400) via the internet and using Bluetooth® or NFC module for exchange of Unique ID, or without a dedicated internet connection using methodology used when describing FIG. 1c.

A business authentication server (405) stores not just information about other business contacts and relationships who its employees met through day to day business operation but also access to business desktop computers at the office (406) connected to the Internet or intranet and with a Bluetooth® or WiFi module. This could enable a user to gain access to the building and a restricted area or even a company's car using electronic locks (407) connected to the Internet or intranet and with a Bluetooth® or WiFi module.

A government authentication server (408) is connected to a desktop computer (409), which automatically displays the information about a citizen at a passport control point connected to the Internet and with a Bluetooth® module. The same technology and methodology could be used to get access to public transport.

Another example is a bank's authentication server (410) with a cash point terminal (411) connected to the Internet and with a Bluetooth® module. A user might be requested to enter a PIN (personal identification number) before money is ejected from the machine or for smaller transactions (like purchasing a newspaper from retailer) with a connected mobile phone device with a Bluetooth® module this might not be necessary because the risk is lower and speed of transaction and simplicity is at a premium.

Additionally to the above methodology explained throughout the document it should be noted that instead of using a BD_ADDR number or BSSID numbers for a Unique ID there could be use of any other identification code using a wireless connection. Such a number could be static (i.e. never changing), or dynamic (i.e. changing through time) where only responsible authentication server knows which Unique ID resolves to which user/entity/object ID at any time. It could be some hardware number stored on the device, or generated by the system on the server or client side. It could be identifying a device or machine, a user, another entity (including but not limited to business, government, organisation etc) or some other entity or object. The full ranges of combinations are not listed exhaustively herein for brevity and for simplicity of this document. Most importantly the use of different user's/entity's Unique Entity IDs or device/machine's Unique IDs than those describes does not depart from the spirit and scope of this invention.

The database representations in FIGS. 4, 5 and 6 are an exemplary embodiment, where the Short Description column is an option and the Unique ID of the user are not necessarily the same as the Primary Key in the database.

All requests from a particular Unique (Entity) ID, even if not mentioned above for sake of brevity, should be positively confirmed with the requestor's authentication server or even with the device making the request. This is to guard against what is known as “spoofing” of a Unique (Entity) ID with the purpose of gaining unauthorised access, where a Unique (Entity) ID request does not come from the expected owner of the Unique (Entity) ID.

Any data, object or link object linked, related or attached to a particular User (Entity) ID can be synchronised or transferred during the process of linking and indeed at any later stage, even if not mentioned above.

As demonstrated by the above description with reference to FIG. 4, the methods described herein provide a distributed system for sharing data in a secure and authenticated manner. Specific data sets/access rights may be allocated to particular devices through storing of identifiers in databases and these may be rescinded by the data/resource owners as required.

Whilst the above description refers to the detection of nearby devices through use of short range communication technologies, other techniques may be used. For example GPS data may be used (e.g. at a pointer server, authentication server or location based services server) to identify devices which are in close proximity to each other. In another example, other positioning technology may be used, such as triangulation (location based services (LBS)) or other techniques which may be used to identify the positions of mobile devices within the cellular telephone networks.

### FURTHER EXAMPLES

The following paragraphs describe further examples and embodiments of the present invention.

A system for facilitating transfer of a unique identification code between devices with the purpose of linking an entity and another entity is provided, the system of at least two separate devices comprising: a first device, with at least one long range communication connection and at least one short range communication connection, a second device, with at least one short range communication connection, at least one database, containing at least one unique identification code.

In this system one or more of the following statements may be applicable:
The system may, in some embodiments, comprise at least two separate databases, each containing at least one unique identification code.
The data stored on the database is related to the unique identification code.
The data is transmitted between the authorised and related databases.
The system also includes a first server with a database connecting and synchronising data to the first device and other servers and databases in the system, provided with authentication data relating to the first device, the first server and database adapted to relate an entity unique identification code and another entity unique identification code.
The system also includes a second server with a database connecting and synchronising data to the second device and other servers and databases in the system, provided with authentication data relating to the second device, the second server and database adapted to relate an entity unique identification code and another entity unique identification code.
The data stored on the database of the second server is related to the unique identification code of the other entity.
The data is transmitted between the authorised databases.
The system also includes a server with a database for accepting, storing and relating an IP address of the first server and the unique identifying code stored on the first server.
The system also includes a server with the database for accepting request from the second server, a unique identification code related to the first server, and responding to the second server with the IP address of the first server.
The system also includes a server adapted to receive and store information from the first server and/or the second server.
The system also includes a server adapted to respond to an enquiring device with the stored information resolved to at least a single unique identification code.
The system also includes a server adapted to periodically back-up the first device.
The system also includes a server adapted to back-up the first device upon device's request.
The first entity related to the device has access to a services offered by a second entity related to the device.
The first entity related to the device has access to authorised personal data associated of a second entity.
The first entity related to the device has control of a second device.

A method for modifying an IP address of a client device so it contains a unique identification code of an entity is described; the method comprising: setting of an network 64-bit (sub-) network prefix of an IP address to network part of an IP address locating the client device on the internet by using an IP address, and setting of a network 64-bit host part of an IP address to network part of an IP address so it contains a unique identification code of an entity.

A method for modifying an IP address of a client device so it contains an IP address of a client's authentication server is described; the method comprising: setting of an network 64-bit (sub-) network prefix of an IP address to network part of an IP address locating the client device on the internet by using an IP address, and setting of a network 64-bit host part of an IP address to network part of an IP address locating the authentication server on the internet by using an IP address.

According to one aspect of the present invention there is provided A networking system for facilitating the establishment of a relationship between a user and a remote device or the user of a remote device,—the networking system comprising: A first system having: A first device, being a wireless mobile Internet connected device being: identifiable by a unique identification code, controlled by a user, adapted to search for proximal wireless devices in response to a user's input via user interface means, adapted to graphically represent identified devices, and adapted to accept a selection of one thereof by the user, A first server related to the first device, provided with authentication data relating to the first device, A second system having: A second device being a wireless device identifiable by a unique identification code, and A second server related to the second device, provided with authentication data relating to the second device, Means for providing an IP address of the second server to the first system,—the networking system specifically adapted such that; On user selection to the first device, of a graphical representation of the second device, the first system is specifically adapted to: determine the IP address of the second server, send a data request to the second server, encoding a request for at least one of the first device and its user, to be henceforth authorised to access the second system, On receipt of such a data request, the second server is adapted to authenticate the user of the first device by at least one of: Requesting verification from a user of the second device, via user interface means of the second device, where access to personal data relating to the user of the second device is requested, or Making a data request to the first server, encoding a request for verification that a user of the first device is seeking such authorisation, where access to a service offered by the second system is requested, On verification, the user of the first device may use the first device to either: access personal data associated with user of the second device, control the second device, or access a service offered by the second server, In the case that the user of the first device instead chooses to use an alternate device, the second server is specifically adapted to: accept remote logon by the user of the first device, with personal user data via the first device, and update at least one of the second server and the alternate first device with authentication data, such that the user may continue to access such personal data, service or control of the second system, via the chosen alternate first device.

A wireless mobile internet connected device specifically adapted for interaction within the networking system described above is also provided which is also specifically adapted to be able to take the role in said networking system of said first device.

A wireless device identifiable by a unique identification code specifically adapted for interaction within the networking system described above is also provided which is specifically adapted to be able to take the role in said networking system of said second device.

A server for authenticating a wireless mobile internet connected device, specifically adapted for interaction within the networking system described above is provided which is specifically adapted to be able to take the role in said networking system of said first server.

A server for authenticating a wireless device, specifically adapted for interaction within the networking system described above is provided which is specifically adapted to be able to take the role in said networking system of said second server.

A server for providing an IP address of the second server to the first system on receipt of a data request encoding the unique identifying code of the second device is provided.

A computer program specifically adapted for any of the devices or servers described above is also provided.

A computer system, device, server or computer program as described with reference to FIGS. 1a to 7 is also provided.

According to an embodiment of the present invention there is provided a method for facilitating exchange/transfer of a unique identification code between devices with the purpose of linking an entity related to a device with an entity related to a second device, the system comprising: A first device, a wireless mobile internet connected device being: Identifiable by a unique identification code related to an entity, Controlled by an entity or automated, Adapted to exchange with other proximal wireless devices the unique identification code using short range communication, Adapted to exchange with other proximal wireless devices the unique identification code using short range communication in response to a user of a wireless device via user interface means, Adapted to check identity of entity behind unique identification code using internet connection, Adapted to graphically represent identified entities, and adapted to accept selection of identified entities, Adapted to make selection which data sets/links/link objects should be related to the selected entity, Adapted to write selection in own database, Adapted to transfer this information to the entity selected, A first server/database connecting to the first device, provided with authentication data relating to the first device, A second device a wireless device identifiable by a unique identification code, and A second server/database connecting to the second device, provided with authentication data relating to the second device, Means for providing an IP address of the second server to the system/server, The system specifically adapted such that; On user activation to the first device, short range communication to collect unique identification code of the second device, Determine IP address of the second server related to the second device, encoding a request for the second server to provide identity of the entity related to the second device, Receive and display identity of the entity related to second device, On user selection to the first device, of graphical representation of identity of the entity related to the second device, the first system is specifically adapted to: Make selection of specific authorisation to access the first device entity information or resources, Encode and transfer such selection to the first server to be written to the first server database and to forward authorisation to the second server related to the second device, After verification of identity, the entity using the first device may: Access object associated with second entity, Control second device, Access the service offered by the second entity, Trigger an event, Act upon or be allowed to act upon a previously granted right.

According to another embodiment of the present invention there is provided a system for facilitating transfer of a unique identification (ID) code between devices with said purpose of linking an entity related to a device and a device and/or an entity related to a device. Said system of at least two separate devices comprising: A first device, a wireless terminal with at least one internet connection and at least one short range communication connection, A second device, a wireless terminal with at least one short range communication connection, At least two separate databases, each containing at least one said unique identification (ID) code.

According to another embodiment of the present invention there is provided a method for facilitating the establishment and repeated verification of authorisation of a user for accessing a service, accessing an object or triggering an event, having the steps of: Registering the user to the user's mobile device, Registering the mobile device to the user's data server, Identifying a unique ID of a remote device wirelessly using the mobile device, Establishing the IP address of an authentication server associated with the unique ID or remote device, Sending a request to that authentication server, encoding a unique ID of the user's mobile device therein, the request being to authorise the user to access a service, access an object, or trigger an event, or to confirm that such authorization was previously granted, Accepting a data request to the server, the request being to confirm that the mobile device is being used for access to the authentication server, Verifying this by communication between the server and the user's mobile device, Sending the requested confirmation by return, and, Accessing the service using the user's mobile device or otherwise, accessing the object, or triggering the event. The event referred to may be, or may trigger, a mechanical, electronic or other action, performed by remote device, another device, a system, an object or an entity, for example opening a lock, displaying information, or performing a sequence of steps in other systems.

According to another embodiment of the present invention there is provided a system with at least one authentication server, at least one database, two devices each using long range communication to connect to the authentication server, and with short range communication (SRC) capability between the two devices (e.g. similar to FIG. 1d). If this SRC is for example NFC, only one nearby device will usually be in close proximity to first device. When devices come in close proximity, at least one or preferably both devices will exchange Unique IDs of devices and/or Unique IDs of entities using the devices. Each will send received Unique ID to the authentication server via respective long range communication connections, and, at authentication server, a link will be formed between the devices or entities using them, by relating their Unique IDs. In another similar scenario, such system could be programmed to ask users for confirmation via the long range communication connection before the link is created.

Alternatively, if a longer range SRC connection is used, for example Bluetooth®, multiple nearby devices may be in close proximity to first device at any time. Enquiring device will read their unique IDs and/or IDs of entities using them and will send received Unique IDs to the authentication server, which may return to device for example a picture or other public data associated with the received Unique IDs. User of device could select one or more pictures and/or other data such as nick name of the user of device with which he wants to link, and this selection is returned to the authentication server, effectively requesting a link to be created. If necessary selected entity/entities are informed via long range communication connection about the request, and may authorize a one- or two-way link enabling only one party to see additional data about other entity or both.

Alternatively, when devices come into proximity, pictures or other public data may also be exchanged directly using SRC connection, instead of the long range communication connection, before or after a link is created.

If there are more than one authentication servers participating in the system IP addresses of authentication servers could be inserted

According to another embodiment of the present invention there is provided a device specifically for performing the role of one of mobile device, remote wireless device, and authentication server, being specifically adapted for such role.

According to another embodiment of the present invention there is provided a computer program specifically adapted for one of the mobile device, remote wireless device, and authentication server in the previous embodiment, for controlling such hardware for use in the system described in another embodiment.

Further embodiments are provided by the selection of any combination of features hereinbefore set out. Further embodiments are set out in the claims.

### CONCLUSION

Whilst in the examples above, an internet connection is described as being used to communicate between devices, this is by way of example only and in this document it is referred to as a general practical term for connecting two separate devices. In other examples, any suitable form of non-short range communication between devices may be used.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to an item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The apparatus and methods disclosed and claimed herein can be made and executed without undue experimentation in light of the present disclosure. While the apparatus and methods of this invention have been described in terms of preferred embodiments, it will be apparent to those skilled in the art that variations may be applied to the apparatus, methods and in the steps or in the sequence of steps of the method described herein without departing from the concept, spirit and scope of the invention. All substitutes and modifications apparent to those skilled in the art are deemed to be within the spirit, scope and concept of the invention as defined by the appended claims.

### TERMINOLOGY

Short range communication may consist of Bluetooth®, WiFi and Infrared standards or substitutes therefore. Other short range communication methods may include use of Near Field Communication (NFC), Ultra-wideband or RFID, for example through the use of active RFID tags which can then be detected by devices nearby. Use of RFID/NFC may be particularly applicable where a wireless device is being used to connect to a resource such as a desktop computer or cash machine or to provide access to services. More generally any magnetic waves and/or particles could be used between devices in close proximity and not just specific technologies available at time of writing this document. Hence whenever specific short range communication methods such as Bluetooth® are mentioned in this document, any magnetic waves and/or particles could be used instead.

Bluetooth® is an industrial specification for wireless personal area networks (PANs). Bluetooth® provides a way to connect and exchange information between devices including but not limited to mobile phones, laptops, PCs, printers, digital cameras, and video game consoles over a secure, globally unlicensed short-range radio frequency. The Bluetooth® specifications are developed and licensed by the Bluetooth® Special Interest Group. Depending on class 3, 2 or 1 of the module it has range of 1, 10 or 100 meters respectively. More information on functioning of Bluetooth® can be found from The Bluetooth® Special Interest Group.

Wi-Fi short range communication is intended to cover all IEEE 802.11 standards and substitutes therefore. The Infrared Data Association (IrDA) defines physical specifications communications protocol standards for the short range exchange of data over infrared light, for uses such as personal area networks (PANs). Ultra-wideband UWB is a radio technology that can be used for short-range high-bandwidth communications by using a large portion of the radio spectrum in a way that doesn't interfere with other more traditional ‘narrow band’ uses.

Radio-frequency identification (RFID) is an automatic identification method for relying on storing and remotely retrieving data using devices called RFID tags or transponders. Near Field Communication (NFC), is a short-range wireless technology which enables the communication between devices over a short distance (up to 5 centimetres).

AJAX shorthand for “Asynchronous JavaScript and XML,” is a web development technique for creating interactive web applications. The intent is to make web pages feel more responsive by exchanging small amounts of data with the server behind the scenes, so that the entire web page does not have to be reloaded each time the user requests a change. This is intended to increase the web page's interactivity, speed, and usability.

SyncML (Synchronization Markup Language) is the former name (currently referred to as: Open Mobile Alliance Data Synchronization and Device Management) for a platform-independent information synchronization open standard. SyncML technology could be used when synchronizing data between different devices including but not limited to mobile phones, desktops, servers, terminals etc. through out this document.

OBEX (abbreviation of OBject EXchange, also termed IrOBEX) is a communications protocol that facilitates the exchange of binary objects between devices. It is maintained by the Infrared Data Association but has also been adopted by the Bluetooth Special Interest Group and the SyncML wing of the Open Mobile Alliance (OMA).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The term “Entity” is used to identify systems such as users, organisations, companies, governments, institutions, associations, establishments, societies, bodies, objects, devices (such as mobile phone devices or devices embedded in a user's clothes or body), machines etc. Entity has a distinct, separate existence, though it need not be a physical existence. The term Entity ID refers to an ID which identifies particular Entity in a specific system. An Entity (and corresponding Entity ID) could contain many users, groups, entities, objects and devices and each contained entity could further include users, groups, entities, objects and devices.

In a broad sense, the term “Object” refers to anything that can be pointed at, named, described or talked about, including but not limited to information, data, a set of data, a pointer to another object, a representation, a set of other objects, a service, a device, a resource, a property, an account.

More specifically, when the term “Object” refers to a collection of data:

It may correspond directly to a contiguous block of computer memory of a specific size at a specific location (although it would be possible to use non-contiguous blocks, i.e. virtual blocks). This could be a file of any type including but not limited to text, picture, sound, video or spatial coordinates, HTML, XML, Binary, formatted as a web page, driver for device, program code compiled or not etc. For example an Object could be a link type as in FIG. 5 next to the number 555 or any data object containing pointer to another Object locally or somewhere remotely. An object may be identified by an Object ID on an entity's authentication server database. The term Object ID refers to an ID which identifies particular Object in a specific system. This object ID may be within a Unique ID. For example the row next to number 555 in FIG. 5 as an Object ID. An object could be a type of link which defines if another entity will have access to a private or a business contact data but it could also be access data for a website, office, bank account or link or pointer (Unique ID) to another entities authentication server or it can be any file for example picture, video, music, text etc. Additionally an object could be an individual unit of run-time data storage that is used as the basic building block of programs. Opposed to a traditional view of a program seen as a collection of functions, or simply as a list of instructions to a computer these objects act upon each other. Objects are capable of receiving messages, processing data, and sending messages to other objects. Each object can be viewed as an independent virtual machine with a distinct role or responsibility.

The term “Unique ID” or Unique Identification Code refers to a data set which is unique for a particular system. It could be generated for general use, or could be dynamically unique, being a specific unique ID for a particular server or database. Alternatively it could be a number used to electronically identify a specific module participating in the system, built-in to the device (for example BD_ADDR, BSSID, SSID, manually set device name of a Bluetooth® or WiFi module). The unique ID will directly or indirectly identify an Entity (which could be a User, an organisation, an object, a Machine or an electronic module built in to the machine). Directly Unique Entity ID (or Entity ID) will resolve to identity of an Entity, while indirectly a Unique ID (usually identifying device, such as Device ID or Unique Device ID) will resolve Unique Entity ID and/or identify an Entity, for example through prior registration or login information. Terms such as “identifier relating to a second device” may refer to both direct and indirect identification of an Entity. In some examples the Entity ID and the Device ID may be the same and in other examples the Entity ID and the Device ID may be different. Unique ID or Unique Entity ID could change through time and/or be valid only between two or more specific users of the system. In an example system and method below there is reference to a Unique ID as a combination of a 32 bit IP address for a particular authentication server with a unique number for the particular user and also a number of a particular object for that particular user. For example in FIG. 5 the database row next to the number 555 represents an object identifying the “Private Link” of a user called “John Smith” and is made of the IP address of John's authentication server (123.123.123.123) the unique number for John Unique user/entity ID (55) and the unique number for John's object called private link Object ID (21), thus the final Unique ID identifying John's private link is 1231231231235521. Object ID and Unique user/entity ID might not be needed to be included inside a Unique ID if for example a single IP address is used by system at any time.

Additionally the system could be designed so that the unique number (or part of it), is periodically changed and updated to the mobile phone device, desktop and all authentication servers and pointer servers connected to it so as to provide greater privacy to the user of the system from malicious monitoring of the Unique ID.

Furthermore, where 128 bit IP addresses are widely available, it will be possible to have a system where just the IP address will uniquely identify each entity. Indeed each unique IP address could represent an object/row in a local database, which would become essentially a unique link between two entities, and thus it would not be necessary to append to an IP address a unique number for a particular user or a number of an object. This will be possible due to the fact that an IPv6 address is divided in two logical parts: a 64-bit (sub-) network prefix, and 64-bit host part. The 64-bit host part could be used for the definition of the exact user and/or object and server as a link between two entities and/or devices. Moreover each link could dynamically change its 64-bit host part over time thus increasing a user's privacy, and potentially contributing to the security of the system. Additionally 64-bit host part of a system device could be changed so it represents an IP address of own authentication server, thus any connected device and authentication server connected to it would be able to contact responsible authentication server for any device by just reading 128 bit IP address version 6 of that device. This could simplify system architecture and make system function much faster.

Another type of number used could be a Universally Unique Identifier (UUID) which is an identifier standard used in software construction, standardized by the Open Software Foundation (OSF) as part of the Distributed Computing Environment (DCE). It has about 3.4×10³⁸ combinations which means that 1 trillion UUIDs have to be created every nanosecond for 10 billion years to exhaust the number of UUIDs. Yet another type of unique ID could be a phone number as it is internationally unique and could be used for initialisation of the system involving but not limited to SMS, MMS, WAP push etc.

Note that if the system or a part of the system is using a Unique ID without including an authentication server IP address, and no pointer server is involved, then a Unique ID must be transferred directly to the authentication server and/or entity/device at least initially using SMS, MMS, email, voice, manual input, or by other means and be related in at least one database to that particular entity and/or device.

A “Link” (or “Bond”) is a relationship between entities (including but not limited to machines, users, organisations, objects or institutions), in which one entity may grant the other entity a certain right, such as access to an object (including but not limited to information, data, set of data, a pointer to another object, a representation, a set of other objects, a service, a device, a resource, a property, an account). The object of a link (or, more generally, the right and its representation) is referred to as a “Link Object”. Each entity, user or device may have one or more Link Objects related to them in the database, and these may be made available to other Entities. The right or access may have different forms, where applicable, such as display access, change access. Also, the entity granting the right or access may be a different entity, or may be the same entity as the one receiving access (for example a person may grant himself access to his own house).

A specific example of a Link Object is a right to trigger an event. This event may, for example, be, or may trigger, a mechanical, electronic or other action, performed by device, remote device, another device, a system, an object or an entity. For example, the event might be opening a lock, executing program code, displaying information, performing a business process, or performing a sequence of steps in other systems, such as executing a money transfer, verifying the identity or authenticity of an entity, performing a credit check or issuing documents.

References to the Link Object are made also using other expressions, such as “type of link” or “link type”. The term “Object ID” may be also understood as referring to a unique identifier of a link object, in a more specific context. The terms “Service” and “Service ID”, depending on context, may refer to specific examples of a Link Object (as in “service being offered by another entity”), but may also refer to the selection of Link Objects (as in “service being offered by the system”).

The term “Bonding” (“Linking”) is a method for building or capturing of relationships (“Bonds” or “Links”) between Entities (including but not limited to machines, users, organisations, objects or institutions). After bonding is completed (a bond is recorded in a database), an Entity figuring in the bond may receive temporary or permanent access to one or more Link Objects related to other Entity. Typically an Entity such as an ordinary person will use their mobile phone device with a short range communication module for bonding with, for example, friends, business colleagues, banks, governments, cars and houses, while an Entity such as an institution might prefer to use a desktop with a short range communication module, to bond with, for example, employees and customers. So a mobile phone device user might gain access to other objects, machines or information (for example a business computer, public transport, a cash point, car or house etc) linked to other Entities utilising short range communication and these entities may all be connected via the internet to the user's system (or their system service provider which ultimately connects to the user's own system).

The term “Mobile Phone Device” may relate to a device comprising one or more of the following elements: a display, a keypad, Read-only Memory (ROM), Random Access Memory (RAM), a long range radio transmitter and receiver for systems (which may include Global System for Mobile Communications (GSM) and its subset General Packet Radio Service (GPRS) or Universal Mobile Telecommunications System (UMTS)), a short range communication module (E.g. Bluetooth®, WiFi and Infrared), a Central Processing Unit (CPU), Speaker, Microphone, Battery, Operating System (OS), software drivers and applications installed on top of the OS necessary for the functioning of the mobile phone device. Mobile phones which permit access to the OS and permit third party software to be installed are known as ‘smartphones’, but it is not necessary for the mobile phone device to have this functionality for utilising the present invention. A typical graphical symbol used in this document to represent a mobile phone device is number (110) in FIG. 1a. The purpose of the mobile phone device within the system is to build, manage and view links between machines, people and entities using its Unique ID. However mobile phone devices are used in the examples described herein by way of example only and any other device may be used such as, for example, any computing device, including but not limited to, Personal Digital Organisers, PC's, Laptops, tablet computers and any terminals with Internet connectivity and/or short range communication, or even devices fully or partially embedded in clothes or inserted in body.

A Desktop Computer with Internet and Bluetooth® module, for the purposes of this document may comprise one or more of the following elements: a display, a keyboard, a pointing device, Read-only Memory (ROM), Random Access Memory (RAM), a Hard Disk with a database, a network card or modem (wireless or not) for accessing the Internet, a short range communication module (Bluetooth®, WiFi, Infrared), a Central Processing Unit (CPU), an Operating System (OS), software drivers and applications installed on top of the OS which may be required for the functioning of the desktop computer. An example of a graphical symbol depicting a desktop computer is number (323) in FIG. 3. Again, any use of a desktop computer in the examples described herein is by way of example only and other devices, such as other computing devices, may be used instead, including but not limited to mobile phones, Personal Digital Organisers, PC's, Laptops, tablet computers and any terminals with Internet connectivity and/or short range communication. The purpose of such desktop machines is to build, manage and view links between devices and entities using a Unique ID.

The term “Pointer Server” may be used to relate to a device comprising one or more of the following elements: Read-only Memory (ROM), Random Access Memory (RAM), a Hard Disk with a database, a network card or a modem (wireless or not) for accessing the Internet, a Central Processing Unit (CPU), a power supply, an Operating System (OS), software drivers and applications installed on top of the OS necessary for the functioning of the pointer server. A purpose of the Pointer Server in this document is to accept a Unique ID sent typically via a short range communication connection between two devices, and then transmitted to the Pointer Server via the Internet, and particularly to relate that Unique ID to a location (including but not limited to an IP address or a Domain Name) of the authentication server which is responsible for authentication of that Unique ID. The separation of the pointer server and the authentication server means that the Pointer Server does not need to be updated each time the user bonds with an Entity, and allows a situation where no other data related to the entity is stored remotely where it might be compromised. The pointer Server's IP address is publicly known by all participants in the system, and every authentication server should store that IP address for use. An example of a graphical symbol depicting a Pointer Server is next to the number (114) in FIG. 1a. Pointer server may also include information such as a PIN for a remote device/s related to particular Unique ID in order to enable encryption of short range communication with another device and thus prevent unwanted nearby devices from intercepting any short range communication.

An Authentication Server may comprise one or more of: Read-only Memory (ROM), Random Access Memory (RAM), a hard disk with a database, a network card or modem (wireless or not) for accessing the Internet, a Central Processing Unit (CPU), a power supply, an Operating System (OS), software drivers, applications and databases installed on top of the OS which may be required for the functioning of the authentication server. The purpose of the authentication server is to relate a Unique ID to a particular entity and/or device. Furthermore an authentication server is used as a relationship manager between the entity and other entities linked to it. Typically a user device including a mobile phone device or a desktop computer will be related directly or indirectly to at least one authentication server. Additionally the authentication server for a particular user could be a mobile phone device itself, holding a database with Unique IDs thereon. A disadvantage of such a system is that when a device is not connected to the network, (E.g. due to poor network coverage, low battery or due to loss or theft) it will be absent from the system and thus unavailable for other connected entities connecting in the background (for example updating or requesting information). Some of these issues could be resolved by adding a back-up system but device availability would remain low and data transfer to and from the device would remain high and possibly cost prohibitive in the short to medium term future. An example of a graphical symbol used to represent an authentication server is number (118) in FIG. 1a (with the exception that (312) is used as a Storage Server in one example). Authentication server may also include information such as PIN for remote device/s related to particular Unique ID in order to enable encryption of short range communication with another device and thus prevents unwanted nearby devices from intercepting any short range communication.

An Entity Name Server may comprise one or more of: Read-only Memory (ROM), Random Access Memory (RAM), a hard disk with a database, a network card or modem (wireless or not) for accessing the Internet, a Central Processing Unit (CPU), a power supply, an Operating System (OS), software drivers and applications and databases installed on top of the OS which may be required for the functioning of the Entity Name Server. A purpose of the Entity Name Server is to enable users to login remotely using any mobile phone device (or wireless machine or desktop) and gain access to resources they previously had registered on their authentication server. The Entity Name Server additionally enables single password login through a website, and for people (or other Entities) to be located by searching a database held by the Entity Name Server. All information about users (and other entities) comes to an Entity Name Server from respective Authentication Servers and may be made available to all those wishing to perform world-wide searches. Another purpose of Entity Name Server is to link an old Unique Entity ID to a new one (with permission from the owner) if for example authentication server IP address has changed or simply because user's data has moved to another authentication server. An Entity Name Server is optional to the system and an example representation is number (121) in FIG. 1a.

A Storage Server may comprise one or more of the following elements: Read-only Memory (ROM), Random Access Memory (RAM), a hard disk with a database, a network card or modem (wireless or not) for accessing the Internet, a Central Processing Unit (CPU), a power supply, an Operating System (OS), software drivers and applications and databases installed on top of the OS necessary for the functioning of the Storage Server. The purpose of a storage server is to enable sharing of other data from a remote location, for example pictures, music, video, etc.

An Entity's Links are data sets stored on the authentication server and generally may be synchronised to a mobile phone device and/or a desktop computer. These data sets include data identifying the user (or other entity) or device. An entity link can have data/information/link objects attached to it and can be a pointer to another link. Every Entity may have at least two types of links: An “Own Link” which identifies or details that particular Entity, and is usually exchangeable, and an “Other Entity Link” which is typically not exchangeable. The purpose of the “Other Entity Link” is for example to have another entity's contact details always available and up to date, or to enable and/or keep access to their resources (including but not limited to a link object, a website, car, bank account etc). Every link between different entities, as well as every link object, can have a status attached to it, such as:
‘Exchangeable’—where the link (or link object) is always exchangeable between different parties, without requiring further authorisation.
‘Exchangeable with permission’—where the link (or link object) is exchangeable between different parties but does require further authorisation from link (or link object) owner for this.
‘Exchangeable with introduction’—where the link (or link object) is exchangeable between different parties, but only if the entity to be introduced comes from an already trusted/linked source and therefore does not require further authorisation from the link (or link object) owner.
‘Exchangeable with permission and introduction’—where the link (or link object) is exchangeable between different parties but only if the entity to be introduced, comes from an already trusted/linked source, and there is further authorisation from the link (or link object) owner.
‘Non-exchangeable’—where the link (or link object) is never exchangeable between different parties.

Typically, “Own Link” consists of the links to a user's own telephone numbers and personal data (E.g. pictures, addresses, videos etc) such as “Private Link” in FIG. 555). Alternatively the data in the “Own Link” could be pointing to a remote authentication server, if for example a user's employer wanted to keep control of their own data and be able to change it as necessary. This is achieved by adding a “Business Link” row (556) in FIG. 5 to the user's authentication server database issued by a user's Business Authentication Server as represented by number (777) in FIG. 7. The user typically has the option to exchange these parts of the link (or link objects) with other entities (including but not limited to people, organisations, objects or machines).

The “Other Entity Link” consists of data which relates to other people and entities. It is typically not editable by a recipient/viewer user (unless originator wants users to maintain this data, for example for feedback, user/customer status or market research), only by the originator/owner and is represented by the database row next to the number (562) in FIG. 5. A typical purpose of this link is to have up to date, rich, contact details of other people and/or entities (E.g. name, telephone number, pictures, video, business contact data etc).

Both parts, the “Own Link” and the “Other Entity Link” may be stored locally by the mobile phone device and/or the respective authentication server, and may be checked as necessary with the originator for their current validity. As well, every originator of the information may notify all users connected to its link as soon as there is any change of information via authentication servers, and this notification may happen automatically.

A “Device” (or “device”) may be any electrical device for handling a particular type of information and performing related tasks. Every device may have at least one Central Processing Unit (CPU) or Microcontroller or other active electronic component for processing and storing information.

As will be apparent to one skilled in the art, systems and parts of systems may be seen as objects, and also may be seen as representations. When one refers to a system or part of a system, depending on the context, one may be referring to objects, to what these objects represent, or to both.

Further, objects outside of a system and their representations within a system are often referred to using the same term. So for example, the term “user” may refer to a physical person in front of a computer, to a representation of this person in a system (perhaps, but not only, a user account), it may refer to their relatedness, it may refer to the pointer function of the representation to the represented, and it may often refer to any combination of these meanings.

So when referring to an entity, it should be always understood that the term used may be referring to the entity outside of the system, or to its representation in the system, or both; in another example, when referring to a “link object”, we may be referring to a representation in the system, or to what the link object in the system represents, or both.

In a more specific example, when referring to “an entity granting access to a link object to another entity”, this may for example refer to granting access to an object outside the system, while this being captured, represented and/or authenticated within the system.

As is common practice, this document avoids distinguishing between these different relational meanings, so that the text is not obscured, and a person skilled in the art is expected to allow for a multitude of interpretations that logic allows.

1. A method for creating a link between entities comprising:
receiving from a first device at a server associated with the first device, an identifier relating to a second device, the identifier having been received by the first device from the second device using a short range communication means;
receiving from the first device at the server associated with the first device, an identifier for a data object; and
making the data object available to an entity associated with the second device by associating the identifier relating to the second device and the identifier for the data object.

2. A method according to claim 1, further comprising:
in response to receiving the identifier relating to the second device, identifying a server associated with the second device;
sending a message to the server associated with the second device, the message including the identifier relating to the second device and an identifier relating to the first device; and
receiving an identifier for an entity associated with the second device from the server associated with the second device.

3. A method according to claim 2, wherein the identifier for an entity associated with the second device and the identifier relating to the second device are the same.

4. A method according to claim 2 or 3, further comprising:
on receipt of an identifier for the entity associated with the second device from the server associated with the second device, sending the identifier for the entity associated with the second device to the first device.

5. A method according to claim 4, wherein the identifier for a data object is received from the first device after sending the identifier for the entity associated with the second device to the first device.

6. A method according to any of claims 2-5, wherein the server associated with the second device is located within the second device.

7. A method according to any of claims 2-6, wherein the server associated with the first device and the server associated with the second device are the same server.

8. A method according to any of claims 2-7, further comprising:
receiving a new data object from the server associated with the second device.

9. A method according to claim 8, further comprising:
receiving from a first device at a server associated with the first device, an identifier relating to a third device, the identifier having been received by the first device from the third device using a short range communication means;
receiving from the first device at the server associated with the first device, an identifier for the new data object; and
making the new data object available to an entity associated with the third device by associating the identifier relating to the third device and the identifier for the data object.

10. A method according to claim 8 or 9, wherein the new data object comprises a new identifier relating to the first device.

11. A method according to any of claims 2-10, wherein the identifier for an entity associated with the second device comprises at least one of a name and a picture of the entity.

12. A method according to any of claims 2-11, further comprising:
sending a confirmation message to the server associated with the second device.

13. A method according to claim 12, wherein the confirmation message comprises an identifier relating to the first device and an identifier for an entity associated with the first device.

14. A method according to claim 13, further comprising, at the server associated with the second device:
sending the identifier for the entity associated with the first device to the second device;
receiving from the second device, an identifier for a second data object; and
making the second data object available to an entity associated with the first device by associating the identifier relating to the first device and the identifier for the second data object.

15. A method according to any of claims 2-14, wherein identifying a server associated with the second device comprises:
identifying an IP address of the server associated with the second device.

16. A method according to claim 15, wherein the identifier relating to the second device includes the IP address of the server associated with the second device.

17. A method according to claim 15, wherein identifying a server associated with the second device comprises:
sending a request to a pointer server asking for at least an IP address of the server associated with the second device, the request including the identifier relating to the second device.

18. A method according to any of the preceding claims, further comprising:
at the first device, in response to a trigger, requesting identifiers relating to any devices in close proximity using the short range communication means.

19. A method according to any of the preceding claims, wherein making the data object available to an entity associated with a device further comprises:
sending the data object to the server associated with the device.

20. A method according to claim 19, further comprising periodically synchronising the data object with the server associated with the device.

21. A method according to claim 19 or 20, further comprising periodically synchronising the data object with the device.

22. A method according to any of the preceding claims, wherein the server associated with the first device is located within the first device.

23. A method for creating a link between entities comprising:
receiving, at a first device over a short range communication means, an identifier relating to a nearby device;
sending the identifier relating to the nearby device to a server associated with the first device;
selecting a data object to share with an entity associated with the nearby device; and
sending an identifier for the data object to the server associated with the first device.

24. A method according to claim 23, further comprising, at the first device prior to receiving an identifier for a nearby device:
in response to a trigger, requesting an identifier of a nearby device in close proximity.

25. A method according to any of claims 23 and 24, further comprising, after sending the identifier relating to the nearby device to the server:
receiving an identifier for the entity associated with the nearby device; and
displaying the identifier for the entity associated with the nearby device.

26. A method according to claim 25, wherein the identifier for the entity associated with the nearby device comprises at least one of a name and a picture of the entity.

27. A method according to any of claims 23-26, further comprising:
amending an identifier relating to the first device to include an address of the server associated with the first device.

28. A method according to any of claims 23-27, further comprising:
sending the data object from the first device to the nearby device over the short range communication means.

29. A method according to claim 28, wherein sending the data object from the first device to the nearby device comprises:
receiving an encryption key from the server associated with the first device;
encrypting the data object using the encryption key; and
sending the encrypted data object from the first device to the nearby device.

30. A method according to any of claims 23-29, wherein if the first device has no long range communication means, sending the identifier relating to the nearby device to a server associated with the first device comprises:
sending the identifier relating to the nearby device over the short range communication means to the nearby device for forwarding to the server associated with the first device over a long range communication means associated with the nearby device.

31. A method according to any of claims 23-30, wherein if the nearby device has no long range communication means, the method further comprises:
receiving a message for forwarding from the nearby device; and
forwarding the message to a server associated with the nearby device over a long range communication means associated with the first device.

32. A method according to any of claims 23-31, further comprising:
receiving a key from the server associated with the first device at one of the first device and the nearby device; and
using the key to access the other of the first device and the nearby device.

33. A system for creating a link between entities, the system comprising:
two wireless devices, each comprising a short range communication means and at least one comprising a long range communication means;
a first server associated with a first of the wireless devices and comprising authentication data relating to the first of the wireless devices;
and wherein the first of the wireless devices is arranged to:
receive an identifier relating to the second of the wireless devices via the short range communication means;
send the identifier relating to the second of the wireless devices to the first server;
select a data object to share with an entity associated with the second of the wireless devices; and
send an identifier for the data object to the first server.

34. A system according to claim 33, wherein the first of the wireless devices includes the server associated with the first of the wireless devices.

35. A system according to claim 33 or 34, wherein the data object selected to share is a predefined object.

36. A system according to any of claims 33-35, wherein the first server is arranged to:
receive the identifier relating to the second of the wireless devices from the first of the wireless devices;
receive the identifier for the data object from the first of the wireless devices; and
make the data object available to an entity associated with the second of the wireless devices by associating the identifier relating to the second of the wireless devices and the identifier for the data object.

37. A system according to any of claims 33-36, further comprising a second server associated with a second of the wireless devices and comprising authentication data relating to the second of the wireless devices.

38. A server comprising:
a data store comprising authentication data associated with a first device;
means for receiving, from the first device, an identifier relating to a second device, the identifier having been received by the first device from the second device using a short range communication means;
means for identifying a data object associated with the first device; and
a data store for storing and associating the identifier relating to the second device and the data object.

39. A server according to claim 38, wherein the means for identifying a data object associated with the first device comprises:
means for receiving, from the first device, an identifier for a data object
and wherein the data store is arranged to store and associate the identifier relating to the second device, the identifier for the data object and the data object.

40. A server according to claim 38 or 39, further comprising:
means for identifying a server associated with the second device;
means for sending a message to the server associated with the second device, the message including the identifier relating to the second device and an identifier relating to the first device; and
means for receiving an identifier for an entity associated with the second device from the server associated with the second device.

41. A server according to claim 40, further comprising:
means for sending the identifier for the entity associated with the second device to the first device.

42. A method for creating a link between entities comprising, at a server:
receiving from a first device an identifier relating to a second device, the identifier having been received by the first device from the second device using a short range communication means and the identifier being received at the server using a long range communication means; and
creating a link between an entity associated with the first device and an entity associated with the second device by associating the identifier relating to the first device and the identifier associated with the second device.

43. A method according to claim 42 further comprising:
receiving from a second device an identifier relating to the first device, the identifier having been received by the second device from the first device using a short range communication means and the identifier being received at the server using a long range communication means;

44. A method according to claim 42 or 43, further comprising:
making a data object associated with the entity associated with the first device available to the entity associated with the second device.

45. A method according to any of claims 42-44, further comprising:
making a data object associated with the entity associated with the second device available to the entity associated with the first device.

46. A method according to any of claims 42-45, wherein the step of creating a link between an entity associated with the first device and an entity associated with the second device by associating the identifier relating to the first device and the identifier associated with the second device comprises:
sending a confirmation request message to at least one of the first device and the second device; and
on receipt of a confirmation message from at least one of the first and the second device, creating a link between an entity associated with the first device and an entity associated with the second device by associating the identifier relating to the first device and the identifier associated with the second device.
